(19) United States
(12) Patent Application Publication
(10) Pub. No.: US 2006/0010945 A1
(43) Pub. Date: Jan. 19, 2006

(54) Programmable lock with temporary access key

(76) Inventor: Rodrick A. Herdman, West Chester, OH (US)

Correspondence Address: HASSE & NESBITT LLC, 7550 CENTRAL PARK BLVD., MASON, OH, 45040, US

(21) Appl. No.: 11/178,627

(22) Filed: Jul. 11, 2005

Related U.S. Application Data
(60) Provisional application No. 60/587,316, filed on Jul. 13, 2004.

(51) Int. Cl. E05B 27/04

(52) U.S. Cl. 70/493; 70/383

(57) ABSTRACT

A programmable lock for unlatching a bolt or a latch, that can be programmed for use with one or a set of main user keys without disassembling the lock or replacing the tumblers. The lock can also be programmed for operation with a temporary access key, associated with the main user key, which can operate the lock. The operation of the lock with the temporary access key can be canceled by again inserting the main user key into the keyway and operating the lock. The lock can also be automatically configured to operate with a second successive main user key that has a different though complementary configuration, by inserting and rotating the second successive main user key in the lock.

### CROSS-REFERENCE TO RELATED APPLICATIONS

This applications claims the benefit of co-pending U.S. Provisional Patent Application No. 60/587,316 filed Jul. 13, 2004.

### BACKGROUND OF THE INVENTION

This invention relates generally to cylinder locks, and more particularly to a programmable cylinder lock that allows for adapting the lock to operate upon insertion of a key having a different configuration than a key to which the lock was originally configured for operation.

In many organizations, such as businesses, apartment buildings, hotels, schools, etc., it is generally desirable to customize the locks to the particular organization. There are two general methods by which keys and locks may be customized. The first involves reconfiguring the drivers and tumblers in the lock so that a key with a particular top edge contour may operate the locks of the organization. The second involves configuring the keyways in the locks to accept keys having a unique pattern of longitudinal contours formed in their sides. The purpose of the exclusivity generated by these methods is to prevent unauthorized entry into the organization. When keys and locks formed by the second method are involved, it is not sufficient for opening the lock that one have a key having a top edge contour appropriate to the lock; the key must also include an appropriate longitudinal contour of grooves and/or ridges.

In general, standard, conventional locks include a housing that has a cylindrical bore therein. An elongated generally cylindrical plug is rotatably mounted within the bore. A plurality of cylindrical apertures or holes extends through the housing and can be aligned with corresponding cylindrical holes in the plug. Paired sets of drivers and tumblers are positioned within these holes (i.e., the drivers within the holes in the housing, the tumblers within the holes in the plug) and are capable of moving within the plug and housing in such a manner as to allow for rotational movement of the plug in response to a main key inserted in the lock. The arrangement and construction of the lock also causes one or more of these sets of drivers or tumblers to be positioned in the interface between the plug and housing to prevent relative rotation between the plug and the housing when the wrong main key or no main key is inserted in the lock. However, the relative positioning of the sets of drivers and tumblers, plug, and housing is such that, when the proper key is inserted, the drivers are substantially wholly within the holes in the housing and the tumblers are substantially wholly within the holes in the plug, such that the plug can be rotated without interference to an unlocking position.

Many locks or sets of locks also include two types of keys: tenant or user keys and master keys. In general, each tenant key will only open one lock of a particular subset of locks, whereas a master key may open all the locks of the subset. Over the course of time, the security of an organization may become compromised by the loss of control of one or more of the tenant keys. For example, in apartment buildings, hotels, or motels, a guest or renter may leave and inadvertently or intentionally retain a key. When this occurs, subsequent occupants or tenants cannot be secure in their persons and property. Thus it would be desirable to easily and quickly reprogram the locks to accept a new key or set of keys.

Locks that can be easily changed are also desired by businesses where several employees are in possession of keys to operate the locks. In such situations, an employee may be discharged or quit, but retain possession of a key. Further, an employee may lose a key, thus placing the security of the locked area in doubt. Locks that can be easily changed are also desired in matters of personal security. One example of such a situation is a school where teachers and/or administrators may wish to quickly change the configuration of locks on classroom doors to secure students inside the classroom and safely set apart from the hallways in the event that an undesirable or dangerous individual breaches the security of the school.

Locks that can be easily changed are also desired by homeowners when a member of the family has misplaced or lost the operative user key, or when the family desires to allow limited access to the house through a temporary reconfiguration of a lock to the house.

When keys are lost or are possessed adversely, the general response is to change the configuration of the tumblers of the lock fitting the lost key, to require a key with a new top edge contour to correspond to the replacement, different-length tumblers. Generally, the shape of the longitudinal inner walls of the keyway that confront the longitudinal contour on the side of the key is not changed due to the generally exorbitant cost of such a change.

There are several generally known methods in the prior art for changing the configuration of drivers and tumblers in standard cylinder locks. Some of these methods involve removing the drivers and tumblers from a lock and replacing them with a different set of drivers and tumblers. However, there are many disadvantages to these prior methods of changing locks. First, these methods are tedious and time consuming. Second, they generally require the presence of a locksmith. And finally, they require disassembly and reassembly of the actual lock structure along with removal and replacement of the lock in a door.

Thus, it would further be desirable to provide a lock that allows the operative key to be changed without removal of the plug from the lock, and/or other disassembly of the lock structure. It would also be desirable to provide a lock that can be temporarily programmed to operate with a temporary key for a limited period of time. It would also be desirable to provide and construct a lock that permits rapid programming of the lock to a different design or configuration to operate with a different user key, and different temporary key.

### SUMMARY OF THE INVENTION

The present invention provides a programmable lock for unlatching a bolt or a latch, that can be programmed for use with one or a set of main user keys without disassembling the lock or replacing the tumblers. The lock can be configured for operation with a temporary access key, associated with the main user key, which can temporarily operate the lock. The main user key can be configured alternatively to cancel operation of the temporary user key, or to continue allowing operation of the temporary user key when the main user key is again inserted into and operates the lock. The lock uses a means for positioning a temporary lock configuration change member within the plug of the lock for establishing the temporary lock configuration. The lock can also be automatically configured to operate with a new user key of a set of the main user keys, which have a different though complementary configuration, by simply using the successive user key in the lock.

The present invention provides a programmable lock assembly that can be reconfigured to operate with different keys of a set of at least one main user key and at least one temporary user key, without disassembling the lock, comprising: a) a housing having a cylindrical bore with an inner surface and a plurality of driver chambers intersecting the inner surface; b) a plurality of drivers movable within a driver chamber; c) a plug having a cylindrical periphery and rotatably mounted within the bore, the plug being rotatable between a key insertion position, a temporary programming position, and a main programming position, the plug further having: a keyway formed in the plug to receive a key selected from the set of keys for rotating the plug within the housing; a plurality of tumbler chambers intersecting the plug periphery and the keyway, each tumbler chamber being aligned with a corresponding one of the driver chambers when the plug is at the key insertion position so as to form a pin chamber, the plurality of pin chambers including at least one programmable pin chamber and at least one temporary pin chamber; 1) at least one main lock configuration retainer cavity formed into the periphery, the main retainer cavity being spaced apart a first distance from the corresponding tumbler chamber associated with the programmable pin chamber, and being aligned with the corresponding driver chamber when the plug is rotated to the main programming position; 2) at least one temporary retainer cavity formed into the periphery, spaced apart a second distance from the corresponding tumbler chamber associated with the temporary pin chamber, and being aligned with the corresponding driver chamber when the plug is rotated to the temporary programming position; and 3) a change slot intersecting the temporary retainer cavity; d) a plurality of tumblers, each tumbler being movable within the corresponding tumbler chamber; e) at least one main lock configuration change member associated with the at least one programmable pin chamber, movable within the lock between a first position within the programmable pin chamber, and a second position within the at least one main retainer cavity, f) a change tool configured for manipulation within the change slot; and g) at least one temporary lock configuration change member associated with the at least one temporary pin chamber, movable within the lock between a first position within the at least one temporary pin chamber, and a second position within the at least one temporary retainer cavity, and being movable from the second position upon manipulation of the change tool in the change slot; wherein the configuration of the lock is based upon the positioning of the at least one main change member and of the at least one temporary change member, and wherein the temporary user key can only rotate the plug from the key insertion position when the temporary change member is disposed in the temporary pin chamber.

The present invention provides a programmable lock assembly that can be reconfigured to operate with different keys of a set of main user keys and temporary user keys, without disassembling the lock, comprising: a) a housing having a cylindrical bore with an inner surface and a plurality of driver chambers intersecting the inner surface; b) a plurality of drivers, each driver being movable within one driver chamber and being urged toward the bore; c) a plug having a cylindrical periphery and rotatably mounted within the bore so as to form a shear line at the interface of the inner surface and the plug periphery, the plug being rotatable between a key insertion position, a temporary programming position, and a main programming position, the plug further having: 1) a keyway formed in the plug to receive a key selected from a subset of keys, the subset of keys including at least a first main user key having a first contour edge, and a second main user key having a second contour edge, wherein the first contour edge and the second contour edge each have a plurality of a contour position and are differently configured; 2) a plurality of tumbler chambers intersecting the plug periphery and the keyway, each tumbler chamber being aligned with one of the plurality of driver chambers when the plug is at the key insertion position so as to form a pin chamber, the plurality of pin chambers including a plurality of programmable pin chambers and at least one temporary pin chamber; 3) a plurality of main lock configuration retainer cavities formed into the periphery, each main retainer cavity being spaced apart a first distance from the corresponding main tumbler chamber associated with a programmable pin chamber, and being aligned with the corresponding driver chamber when the plug is at the main programming position; 4) at least one temporary lock configuration retainer cavity formed into the periphery, the at least one temporary retainer cavity being spaced apart a second distance from the corresponding tumbler chamber associated with the at least one temporary pin chamber, and aligned with the corresponding driver chamber when the plug is at the temporary programming position; and 5) a change slot that intersects a portion of the at least one temporary retainer cavity; d) a plurality of tumblers, each tumbler being movable within the corresponding tumbler chamber; e) a plurality of main lock configuration change members, each main change member being associated with one programmable pin chamber, and being movable within the lock between a first position within the corresponding programmable pin chamber, and a second position within the corresponding main retainer cavity, f) a change tool configured for manipulation within the change slot; and g) a temporary lock configuration change member associated with the at least one temporary pin chamber, and being movable within the lock between a first position within the at least one temporary pin chamber, and a second position within the at least one temporary retainer cavity, and being movable from the second position upon manipulation of the change tool in the change slot; wherein a first main user key can operate the lock in a first lock configuration having a first number of the main change members disposed in the corresponding programmable pin chambers, but can not operate the lock in a second lock configuration having a second number of the main change members disposed in the corresponding programmable pin chamber that is less than the first number, and wherein the temporary user key associated with the main user key can only rotate the plug from the key insertion position when the at least one temporary change member is disposed in the first position.

The present invention provides further a programmable lock assembly that can be reconfigured to operate with different keys of a set of user keys, without disassembling the lock, comprising: a) a housing having a cylindrical bore, and a plurality of main driver chambers and a temporary driver chamber that intersect the bore; b) a plurality of drivers, each driver being movable within one driver chamber and being urged toward the bore surface; c) a plug rotatably mounted within the bore so as to form a shear line at the interface of the bore and the plug periphery, the plug being rotatable in a first direction between a key insertion position, a main programming position, and a temporary programming position, the plug further having: 1) a longitudinal axis; 2) a keyway configured to receive a key selected from the set of user keys; 3) a plurality of tumbler chambers intersecting the plug periphery and the keyway, each tumbler chamber being aligned with corresponding plurality of driver chambers when the plug is at the key insertion position and wherein at least one of the tumbler chambers is a main tumbler chamber; 4) at least one retainer cavity formed into the periphery, and aligned with the at least one main configuration driver chamber when the plug is at the main programming position; 5) a temporary retainer cavity formed into the periphery, and aligned with the temporary driver chamber when the plug is at the temporary programming position; and 6) a change slot that intersects the temporary retainer cavity; d) a plurality of tumblers, each tumbler being movable within the corresponding tumbler chamber; e) at least one main lock configuration change member, the at least one main change member being associated with the at least one main tumbler chamber, and being movable within the lock from a first position within the main tumbler chamber, to a second position within the corresponding configuration retainer cavity, and f) a temporary change member, movable between the temporary driver chamber and the temporary retainer cavity, and being movable from the temporary retainer cavity upon manipulation of a change tool in the change slot.

The present invention further provides a lock kit, comprising a programmable lock assembly according to the invention; b) a set of keys comprising at least one main user key and at least one temporary user key associated with the programmable lock assembly; c) instructions for use of the set of keys in the programmable lock assembly; and d) a means for securing together the set of keys, programmable lock assembly, and the instructions.

The present invention also provides a programmable lock assembly that can be reconfigured to operate with different keys of a set of a main user key and a temporary user key, without disassembling the lock, comprising: a) a housing having a cylindrical bore with an inner surface and a plurality of driver chambers intersecting the inner surface; b) a plurality of drivers movable within a driver chamber; c) a plug having a cylindrical periphery and rotatably mounted within the bore, the plug being rotatable at least in a first direction between a key insertion position, and a temporary programming position, the plug further having: 1) a longitudinal axis; 2) a keyway formed in the plug to receive a key selected from the set of keys; 3) a plurality of tumbler chambers intersecting the plug periphery and the keyway, each tumbler chamber being aligned with a corresponding one of the driver chambers when the plug is at the key insertion position so as to form a pin chamber, the plurality of pin chambers including at least one temporary pin chamber; 4) a temporary retainer cavity formed into the periphery, spaced apart a distance from the corresponding tumbler chamber associated with the temporary pin chamber, and aligned with the corresponding driver chamber when the plug is rotated to the temporary programming position; and 5) a change slot extending proximate the temporary retainer cavity; d) a plurality of tumblers, each movable within the corresponding tumbler chamber; e) a change tool configured for manipulation with the change slot; and f) a temporary change member associated with the temporary pin chamber, movable within the lock between a first position within the temporary pin chamber, and a second position within the temporary retainer cavity, and being movable from the second position upon manipulation of the change tool in the change slot; Wherein the temporary user key can only rotate the plug from the key insertion position when the temporary change member is in the temporary pin chamber.

The present invention provides also a programmable lock assembly that can be reconfigured to operate with different keys of a set of keys comprising a main user key and a temporary user key, without disassembling the lock, comprising: a) a housing having a cylindrical bore with an inner surface and a plurality of driver chambers intersecting the inner surface; b) a plurality of drivers movable within a driver chamber; c) a plug having a cylindrical periphery and rotatably mounted within the bore, the plug being rotatable between a key insertion position, a temporary programming position, and an operating position, the plug further having: 1) a keyway formed in the plug to receive a key selected from the set of keys; 2) a plurality of tumbler chambers intersecting the plug periphery and the keyway, each tumbler chamber being aligned with a driver chamber when the plug is at the key insertion position so as to form a pin chamber, the plurality of pin chambers including at least one temporary pin chamber; 3) at least one temporary retainer cavity formed into the periphery, spaced apart a second distance from the corresponding tumbler chamber associated with the at least one temporary pin chamber, and aligned with a corresponding driver chamber when the plug is rotated to the temporary programming position; and 4) a change slot that intersects the at least one temporary retainer cavity; d) a plurality of tumblers movable within the corresponding tumbler chambers; e) a change tool configured for manipulation within the change slot; and f) at least one temporary lock configuration change member associated with each at least one temporary pin chamber, being movable within the lock between a first position within the temporary pin chamber, and a second position within the at least one temporary retainer cavity, and being movable from the second position upon manipulation of the change tool in the change slot; wherein the at least one temporary user key can only rotate the plug away from the key insertion position when the temporary change member is in its first position.

The present invention also relates to a programmable lock assembly, essentially as described above, having at least one, and preferably a plurality of, main change members that can be moved within the plug from a first position in a corresponding pin chamber to a second position in a corresponding main retainer cavity, solely in response to insertion of a successive main user key and rotation of the plug to the main programming position, without the use of a tool or implement, and a temporary change member that can be moved within the plug from a first position in a temporary pin chamber to a second position in a temporary retainer cavity, wherein a change tool can be manipulated to move the temporary change member out of the temporary retainer cavity and back into the temporary pin chamber. Typically, the main change balls can not be removed from the main retainer cavities unless the lock is disassembled, such that their movement to the main retainer cavities is essentially irreversible.

### BRIEF DESCRIPTION OF THE DRAWINGS

The accompanying drawings, which are incorporated in and constitute a part of this specification, illustrate embodiments of the invention and, together with a general description of the invention given above, and the detailed description of the embodiments given below, serve to explain the principles of the invention.

FIG. 1 shows a perspective view of a programmable lock of the present invention having a housing and a plug therein, having at least one main lock configuration retainer cavity, at least one main lock configuration change member, a temporary lock configuration retainer cavity, and a temporary lock configuration change member.

FIG. 2 shows an exploded perspective view of the lock of FIG. 1.

FIG. 3 shows a perspective view of the programmable lock with partially cut-away of the housing.

FIG. 4 shows a perspective view of the programmable lock with partially cut-away of the housing and the plug, when the lock is configured for operation with a first main user key.

FIG. 5 shows a partially cut-away, perspective view of the programmable lock with the first main user key inserted.

FIG. 6 is a cross sectional view of the programmable lock shown in FIG. 5 through line 6-6.

FIG. 7 shows a first, second, third and fourth main user key, and a first temporary user key, associated with the programmable lock.

FIG. 8 shows a cross sectional view of the programmable lock of FIG. 4 through line 8-8.

FIG. 9A shows an integral change tool assembly for use on the programmable lock of the invention, having a change tool and a slot body.

FIG. 9B shows a cross sectional view of the slot body shown in FIG. 9A through line 9B-9B.

FIG. 10 shows another embodiment of a change tool associated with the programmable lock.

FIG. 11 shows the lock and key shown in FIG. 5, partially rotated to a temporary programming position and unlock position.

FIG. 12 shows the lock and key shown in FIG. 5, rotated to the temporary programming position.

FIG. 13 shows the lock and key shown in FIG. 12, with the change tool manipulated to move a temporary change member out of the temporary retainer cavity.

FIG. 14 shows a cross sectional view of the lock and key shown in FIG. 13 taken through line 14-14.

FIG. 15 shows a cross sectional view of the lock and key shown in FIG. 13 taken through line 15-15 of FIG. 14.

FIG. 16 shows the lock and key of FIG. 13, partially rotated back to the initial position.

FIG. 17 shows the lock and key of FIG. 13, rotated back to the initial position.

FIG. 18 shows the lock and key of FIG. 17 with the user key removed, configured for operation with a temporary user key.

FIG. 19 shows the lock and key of FIG. 18 with the temporary user key inserted.

FIG. 20 shows the lock and key of FIG. 19, rotated to the unlock position.

FIG. 21 shows the lock and key of FIG. 18 with the operable user key inserted.

FIG. 22 shows the lock and key of FIG. 21, rotated toward the unlock position.

FIG. 23 shows the lock and key of FIG. 22, in the unlock position, with the temporary change member disposed in the temporary retainer cavity.

FIG. 24 shows the lock of FIG. 23 in the key insertion position, with a second main user key inserted.

FIG. 25 shows a cross sectional view of the lock and second user key of FIG. 24 taken through line 25-25.

FIG. 26 shows the lock and key of FIG. 24, partially rotated toward a main programming position, with a first main change member disposed in the first driver chamber.

FIG. 27 shows the lock and key of FIG. 24 in the main programming position, with the first main change member disposed in the first configuration retainer cavity.

FIG. 28 shows the lock and key of FIG. 24 in the unlocking position, configured for operation with the second main user key.

FIG. 29 shows the lock and key of FIG. 28, rotated back to the key insertion position.

FIG. 30 shows the lock of FIG. 29, with a third main user key inserted.

FIG. 31 shows a second embodiment of the lock configured for and being operated with the first main user key, rotated to the main programming position, with a separate change tool inserted into move the temporary change ball out of its retainer cavity.

FIG. 32 shows a perspective view of an embodiment of the programmable lock, with a rotation positioning means.

FIG. 33 shows a perspective view of a third embodiment of the programmable lock having a housing and a plug therein, having a temporary retainer cavity and a temporary change member.

FIG. 34 shows a partially cut-away, perspective view of the programmable lock of FIG. 33 that is configured for operation with an installed main user key.

FIG. 35 shows an alternative embodiment of the lock, configured for operation with a non-canceling main user key 140N when the lock is in temporary lock configuration.

FIG. 36 shows the canceling first main key 140C and a non-canceling first main user key 140N.

FIG. 37 shows a lock kit containing the programmable lock, keys and instructions for use.

### DETAILED DESCRIPTION OF THE INVENTION

The programmable lock typically includes a housing with a bore and a plug (or lock core) rotatably mounted within the housing. The housing has a barrel portion having a cylindrical bore with a longitudinal axis, and a stack portion extending outwardly from the barrel portion. The stack portion of the housing has a plurality of holes or driver chambers extending radially from the centerline of the housing bore, which intersect the bore. The housing is typically inserted into a suitably configured opening in a door, a body of a padlock, or another object, where operation of the lock can open, and optionally close, a latch or other means for securing the door, padlock or object.

The plug has a longitudinal axis and a keyway that is configured to receive a key. Rotation of the plug within the bore of the housing establishes a shear line or arc at the intersection of the driver chamber and the bore. The plug has a plurality of radially extending holes or tumbler chambers that penetrate the periphery and intersect with the keyway.

The tumbler chambers and the driver chambers receive, respectively, the drivers and tumblers of the lock. When the plug is in a first position within the housing bore, the alignment of the radially-extending tumbler chambers with the radially-extending driver chambers form a plurality of pin chambers. This position of the plug within the housing is also termed the key insertion position. Each pin chamber is provided with a tumbler that is positioned for axial movement within the tumbler chamber, and a driver that is positioned for axial movement within the driver chamber. Either the driver or tumbler can extend from the respective driver chamber or tumbler chamber to span across the shear line, in which condition the plug can not rotate away from the key insertion position.

The plug is configured with a first row of at least one hole or cavity, aligned along the axis of the plug. The temporary retainer cavity receives a corresponding at least one temporary change member. The temporary change member can move between a first position within the temporary pin chamber, and a second position within the temporary retainer cavity. When the temporary change member is positioned in its first position within the temporary pin chamber, the lock is temporarily configured for operation with a temporary user key. A key of the set of keys is operable in the lock, or the lock is operable with a key, if the lock is in a configuration where, upon insertion of the key into the keyway, the plug can be rotated away from the key insertion position.

The lock can be programmed for operation with a temporary user key that is associated with an operable main user key by operating the plug of the lock to a temporary programming position, where the temporary retainer cavity aligns with the corresponding driver chamber associated with the temporary pin chamber, and manipulating a change tool within a change slot. The change slot is disposed at least adjacent to, and more typically intersecting with, the temporary retainer cavity. The change tool comprises a lifting portion that intersects with the temporary retainer cavity when the change tool is manipulated, thereby displacing the temporary change member out of the temporary retainer cavity and into the driver chamber associated with the temporary pin chamber. The change tooling comprising the integral change tool 50 is configured integrally with the plug, and comprises at least one biasing member associated with the temporary retainer cavity, and being moveable between a first position where the biasing member does not intersect the temporary change cavity, and a second position where the biasing member does intersect the temporary change cavity. The temporary retainer cavity is configured to retain the temporary change member when the change tooling is in its first position. Manipulation of the change tooling to the second position causes the biasing member to displace the temporary change member from the retainer cavity.

In a typical embodiment, when the main user key for which the lock is configured for operation is then inserted into the keyway and is turned to operate the lock, the temporary change member is moved, automatically and without using any tool, from the temporary pin chamber to its second position within the temporary retainer cavity, thereby inactivating the temporary user key. Consequently, configuration of the lock for the temporary user key does not change the lock configuration of the main lock configuration change members, and does not affect the operation of the lock by the operable main user key, but does change the configuration of the temporary change member.

Alternatively, the lock can be configured for operation of a non-canceling main user key that that does not cancel the temporary lock configuration, by preventing the temporary change member from being moved out of the pin chamber and into the temporary retainer cavity. This can be accomplished in one embodiment by providing a mastering shim below the temporary change member in the temporary pin chamber. The tumbler length and/or the contour of the non-canceling main user key at the temporary pin chamber position is configured to raise the mastering shim up with the temporary change member into the driver chamber, whereby the mastering shim blocks passage of the temporary change member into the temporary retainer cavity. In this alternative lock embodiment using a mastering shim, an ordinary or canceling main user key is also provided that cancels the temporary lock configuration, by raising only the temporary change member above the shear line of the plug, with the mastering shim remaining below the hear line within the tumbler chamber.

The plug can also be configured for operation with a set of main user keys, which have top edge contours that are complementary though different. The set of keys comprises a series of main user keys that provide, when used successively in series, automatic changing of the configuration of the lock to operate with the successive user keys of the series and to cancel operation of the preceding user keys of the series. The lock has at least one, and typically two or more, of the pin chambers configured and designated as programmable pin chambers. Each programmable pin chamber is associated with a main lock configuration change member and with a main lock configuration retainer cavity. At least one, and typically a plurality of, main retainer cavity forms a second row of holes or cavities in the periphery, typically aligned along the axis of the plug. In its first position, the main change member resides within the programmable pin chamber between the tumbler and the driver. In its second position within the lock, the change member can reside within a separate main lock configuration retainer recess or cavity located in or otherwise associated with the plug. This main change member typically has a size, and diameter, smaller than that of the driver and tumbler. By moving one or more main change members between one or more of the programmable pin chambers and the main retainer cavities, the main lock configuration can be programmed to operate with one of the set of main user keys.

The plug can rotate within the housing in a first direction, from its first or key insertion position, to a second position that is typically the unlock position, and can rotate in a second direction, from its first position to a third operating position, which is typically the lock position, when configured for operation with the main user key. In alternative embodiments, the lock can be configured for plug operation rotation in only one direction, as described in co-pending U.S. patent application 60/592,456, attorney docket number EZL-004P, filed Jul. 30, 2004, incorporated herein by reference.

Each user key of the set of main and temporary user keys has a blade portion that is inserted into the keyway. The blade has a top contour that defines a plurality of contour positions of varying height. When inserted into the keyway, the contour positions raise the respective tumbler, driver, and any main or temporary change member (if present) within the pin chambers. Generally, if either the driver or tumbler bodies span across the shear line, then the plug will not rotate within the housing.

Each main user key is configured to provide a plurality of contour positions along its length, each position associated with a pin chamber along the length of the plug. The contour positions associated with the programming pin chambers are configured as either a raised position or a lowered position. The series of main user keys are complementary in that each successive user key in the series has raised contour positions corresponding to the raised contours positions of the preceding user key(s). The series of main user keys are different in that each successive user key in the series has at least one additional raised contour position. That is, the first main user key in the series can have no raised contour positions, or at least one raised contour position; the second main user key has a configuration similar to the first key, but also has at least one additional raised contour position; the third main user key has a similar configuration as the second key, but also has at least one additional raised contour position; and so forth.

When the lock can be operated with a plurality of main user keys, and configured for operation with the first main user key, insertion of the second main user key causes a main lock configuration change member positioned in a programming pin chamber that is associated with the one additional raised contour position, to rise above the plug shear line. Rotation of the plug, typically to the unlock position, with the second user key isolates the change member in the corresponding driver chamber. When the driver chamber aligns with the corresponding main retainer cavity, the main change member is urged out from the driver chamber, and into the corresponding main retainer cavity. This changes the main configuration of the lock for operation with the second main user key, and disables operation with the first main user key and any associated first temporary key. Likewise, the lock can be configured for operation with a third main user key in the series of main user keys simply by inserting the third main user key and rotating the plug to the main programming position, typically in the first direction to the unlock position.

To program the lock for use with a temporary user key that is associated with an operable main user key, the temporary change member has to be moved from its second position within the temporary retainer cavity, into its first position in the corresponding temporary pin chamber. First, the operable main user key can be inserted into the keyway, and the plug is rotated to the temporary programming position, typically also toward the unlock position. In the temporary programming position, the temporary change member is typically moved or biased from the temporary retainer cavity with a means for displacing the temporary change member from the temporary change cavity. A typical displacing means is a change tool. The change tool typically is an elongated member that can be manipulated in a change slot that intersects the temporary retainer cavity. In one embodiment of a change tool, a biasing edge of the change tool contacts the temporary change member, and raises the temporary change member out of its retainer cavity and into its corresponding driver chamber. As the plug is rotated back to the key insertion position, the temporary change member becomes isolated within the corresponding driver chamber. The change tool can then be moved, or removed, to disengage the biasing edge from the temporary retainer cavity. With the temporary change member disposed in the temporary pin chamber, the lock is in a temporary access configuration, where the lock can operate with a temporary user key that is specifically associated with the operable main user key. The temporary user key has a configuration similar to the operable user key associated with the main lock configuration, except that the temporary contour position that is associated with the temporary pin chamber has a lowered contour. The lowered contour of the temporary contour position raises the tumbler and the temporary change member, which typically raises the lower end of the corresponding driver to the shear line to enable plug rotation. Typically the operation of the lock by the temporary user key can be cancelled at any time, by inserting an operable user key into the keyway and rotating the plug.

### DETAILED EMBODIMENTS OF THE INVENTION

A first embodiment of a programmable lock assembly of the present invention is shown in FIGS. 1 through 6. This embodiment shows a programmable lock assembly that can be programmed to operate with at least one, and typically with one of a plurality of, main user keys. The lock operates with a main user key to rotate from the initial key insertion position in a first direction, to a second position, typically the unlock position. The embodiment of the programmable lock can have a series of up to five main user keys in a typical six-chamber lock assembly, each configured to change the lock configuration and operate the lock in successive order. Each successive main user key in the series can be associated with a successive temporary key. By programming the lock with a change tool, the temporary user key can operate the lock until cancelled by an operable main user key.

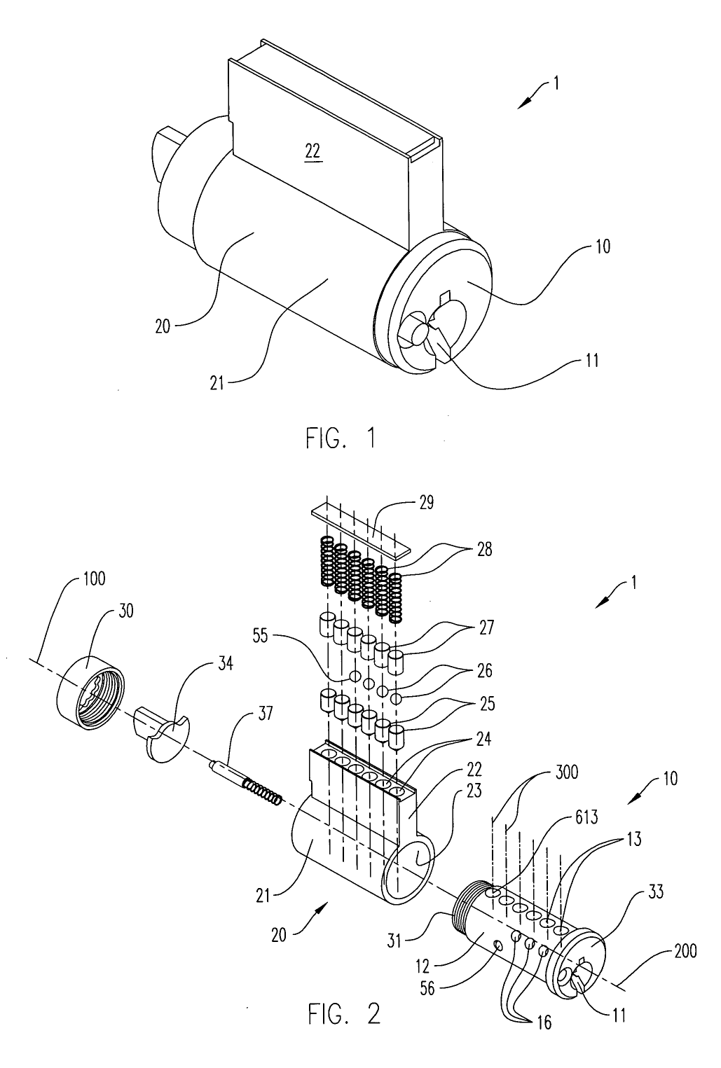

FIGS. 1 and 2 show the lock assembly 1 that includes a housing 20 having a cylindrical barrel portion 21 and a stack portion 22. The barrel portion 21 has a cylindrical bore that runs through the length of the barrel portion 21 to form an inner surface 23. A plurality of driver chambers 24 are formed along the length of the stack portion 22, and intersect the inner surface 23. In the illustrated embodiment, the driver chambers 24 have the same diameter, and are aligned along the centerline 100 that passes through the longitudinal center of the barrel portion 21.

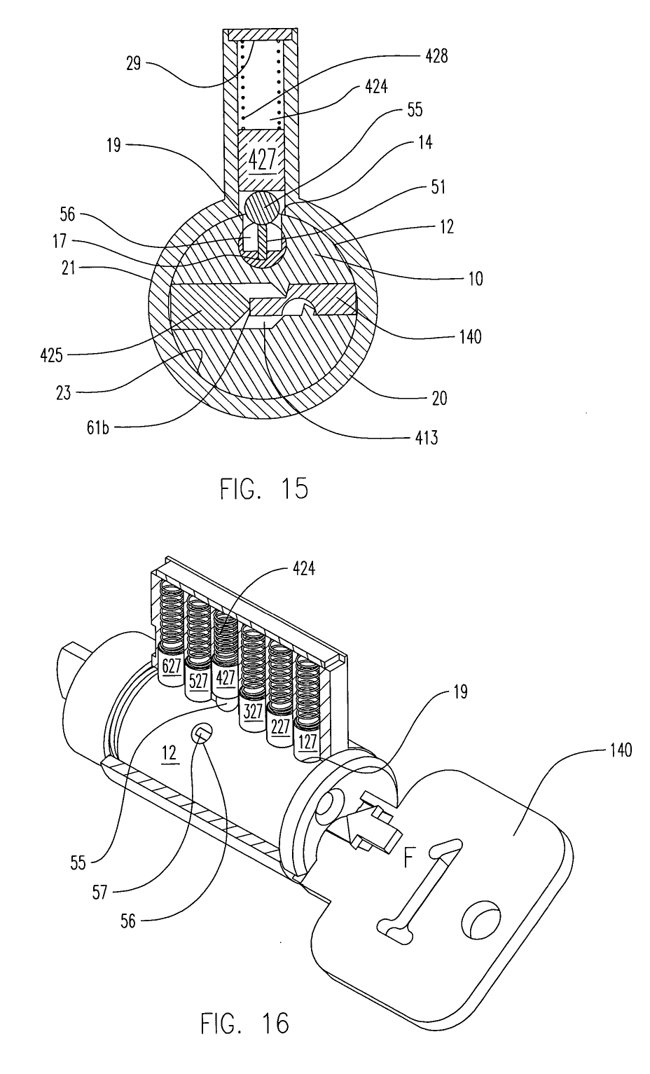

A plug 10 of the lock has a cylindrical periphery 12 that is formed or machined to allow the plug 10 to be mounted rotatably within the inner surface 23 of the barrel portion 21 of the housing, such that the centerline 200 of the plug 10 is aligned along the centerline 100. A cylindrical shear surface is formed at the interface between the periphery 12 of the plug 10 and the inner surface 23 of the housing 20. A shear line or arc 19 is formed at the intersection of the periphery 12 of the plug 10, and the juncture of the inner surface 23 with the driver chambers 24 (see FIG. 15).

The lock 1 operates under the well-known principle that, provided none of the lock hardware (the lock drivers and tumblers, discussed herein after) span across the shear line or shear arc 19, then the plug 10 is free to rotate within the bore, and the lock operates to open or close a latch, a bolt or other means of securing a door or other device being secured closed by the lock. On the other hand, if a driver or a tumbler spans across the shear line 19, then the plug 10 is prevented from rotating within the housing.

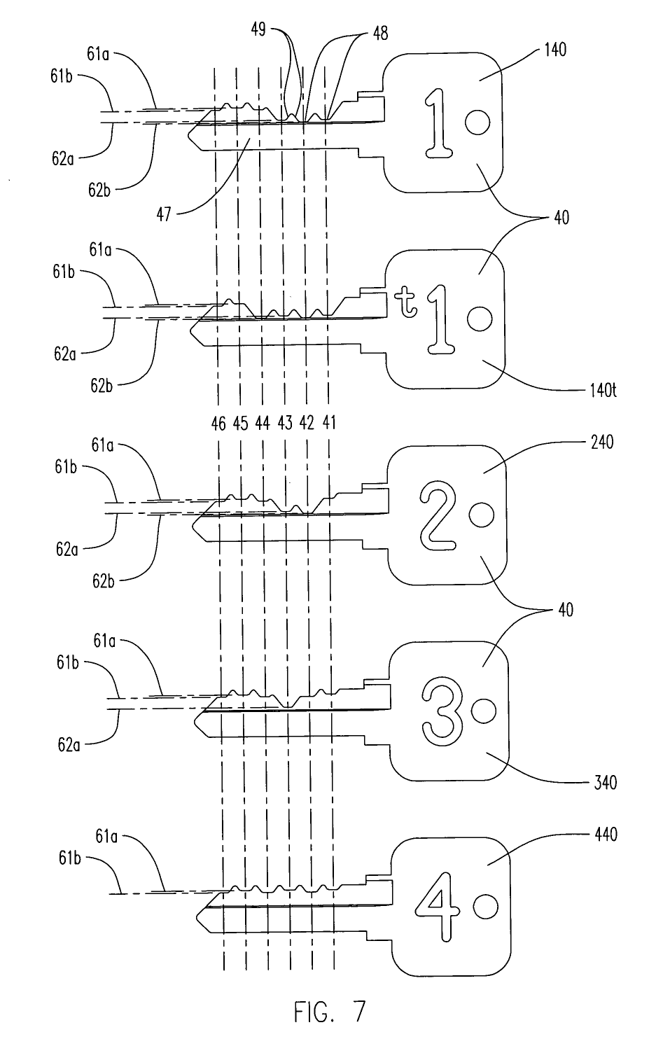

The plug 10 has a keyway 11 that has been bored or machined out of the plug 10 to provide a passageway for an associated key 40, shown in FIG. 7. Typically, the keyway 11 extends longitudinally from the front face 33 of the plug toward the rear. The cross sectional shape of the keyway 11 typically remains constant along the longitudinal axis 100 of the plug 10, and is configured to receive a corresponding shaft portion 47 of a key 40 (shown in FIG. 7) that has a complementary cross sectional shape along its longitudinal length, as is well-known and practiced in the lock industry.

The plug 10 has a plurality of tumbler chambers 13 that penetrate from the plug periphery 12 through the body of the plug 10 to intersect the keyway 11. The tumbler chambers 13 lie generally in a plane that extends through the keyway 11. As shown in the illustrated embodiment, the tumbler chambers 13 are generally of the same diameter, and are equally spaced and aligned along the longitudinal length of the plug 10. Each tumbler chamber 13 is formed or machined along a centerline 300 that intersects and is perpendicular to the centerline 200 of the plug. When the tumbler chambers 13 of the plug 10 are axially aligned with the driver chambers 24 of the stack portion 22, as shown in FIGS. 1, 3 and 4, the plug 10 is in a first rotated position with the respect to the housing 20. This position is also the key insertion position.

The latch end of the plug can be provided with a means of securement, such as machined threads 31, which can extend from the end of the housing 20, and can receive a correspondingly-threaded cap 30 to secure the plug 10 within the housing 20. A latch 34 can be retained by the cap 30, which cooperates with a stop pin 37 to limit rotation of the latch relative to the plug. The latch 34 can engage a recess or bolt (not shown) to unlock (open) or lock (close) the object, such as a door, padlock, etc., in which the lock 1 is installed.

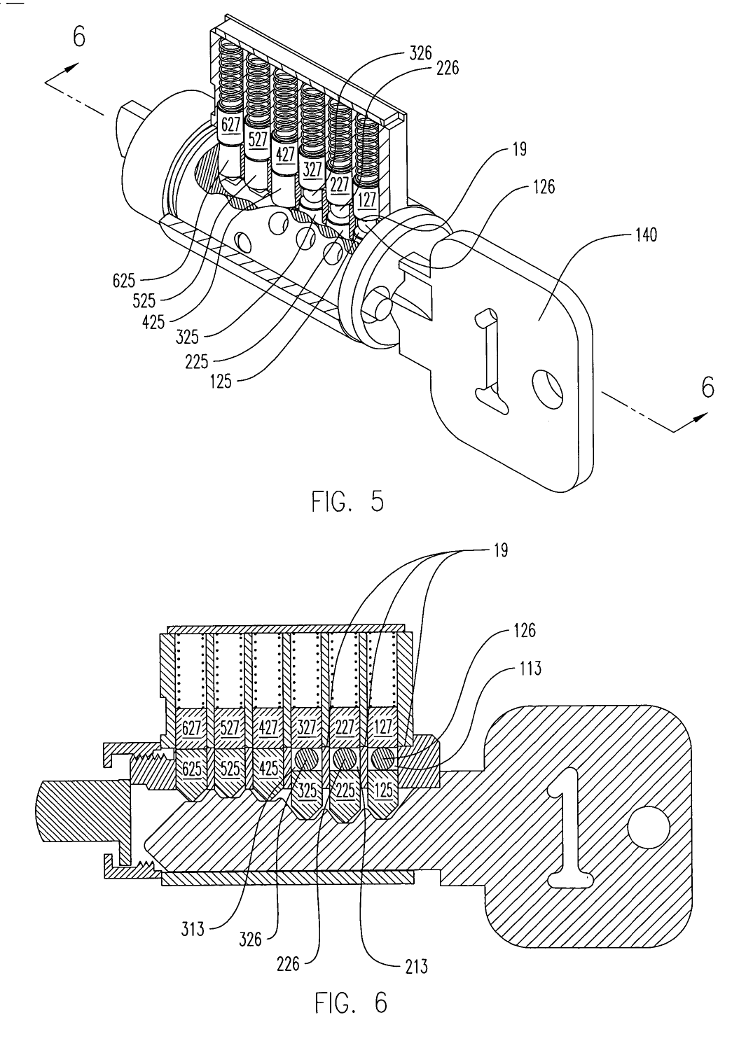

The lock 1 also comprises a plurality of lock hardware elements, comprising a plurality of tumblers 25, drivers 27, driver springs 28, and change members 26. Typically, each pin chamber, formed from an aligned tumbler chamber 13 and driver chamber 24 when the plug 10 is in its first rotated position, comprises, in sequence, one tumbler 25, one change member 26 (when present), one driver 27 and one driver spring 28. The first three pin chambers are illustrated as programming pin chambers. A main lock configuration change member 26 is disposed in each of the first three pin chambers, between the tumbler 25 and the driver 27, and the three main change members are shown in FIG. 5 as change members 126, 226, and 326.

The tumblers 25 are generally pencil-shaped, and typically consist of a cylindrical body with a tapered or conical end. Each tumbler 25 is moveable axially along and within the tumbler chamber 13, and positioned with the tapered end extending into the keyway 11 when no key is inserted. The driver 27 typically has a cylindrical body. Each driver 27 is positioned within driver chamber 24 of the stack portion 22 of the housing, and is moveable axially along and within the driver chamber 24. A driver spring 28 biases the driver 27 toward the shear line 19 and inner surface 23 of the housing 20. The driver spring 28 is typically made of a tempered stainless steel to prevent material deformation upon multiple cycles of compression and extension. Preferably, the spring material is a non-metallic stainless steel wire of about size 008, and is available as part number C108x008×520 from W.B. Jones Spring Co., Inc., of Wilder, Ky. A planar lid 29 can be secured in position to the top of the stack portion 22 to retain the hardware elements after these have been loaded into the pin chambers.

The main lock configuration change member 26 is illustrated as a spherical ball. The spherical shape of the main change member 26 allows rolling movement within the driver chambers 24, tumbler chambers 13, and other passageways in the lock, and projects the same cross-sectional shape (circular) regardless of its orientation. The spherical shape of the change member 26 eliminates corners or edges that can obstruct its free movement. A barrel- or cylindrical-shaped change member can be used in a lock of the present invention, although it may have a tendency to tilt or tumble within a chamber, which can increase the potential of becoming lodged within the chamber and jamming the lock. For the purpose of describing succeeding embodiments of the present invention, the configuration change member will hereinafter be referred to as the change ball 26.

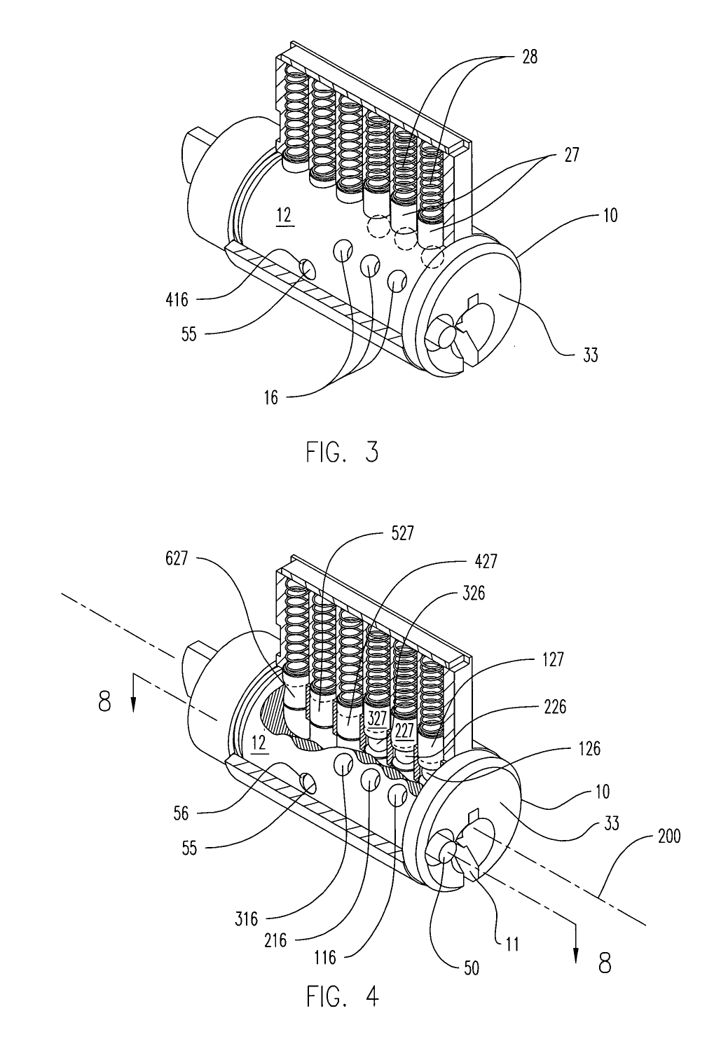

As shown in FIGS. 3 and 4, the plug 10 has a plurality of main retainer cavities 16 machined into the periphery 12 of the plug 10. In the illustrated embodiment shown in FIG. 4, there are three main retainer cavities 116, 216 and 316 of substantially the same circular cross section. The three main retainer cavities 116, 216 and 316 correspond to the first three programming pin chambers of the lock. The retainer cavities are shown aligned along and disposed perpendicularly to the longitudinal axis 200 of the plug, and are equally spaced, and axially aligned and circumferentially displaced from a corresponding tumbler chamber 113, 213 and 313 of the plug 10, shown in FIG. 6. Typically the diameter or minimum opening of the main retainer cavity 16 is larger than, and typically just slightly larger than, the diameter of the main change ball 26. In the illustrated embodiment, the depth of the bore or cavity of the main retainer cavity 16, from the periphery 12, is at least the diameter of the main change ball 26.

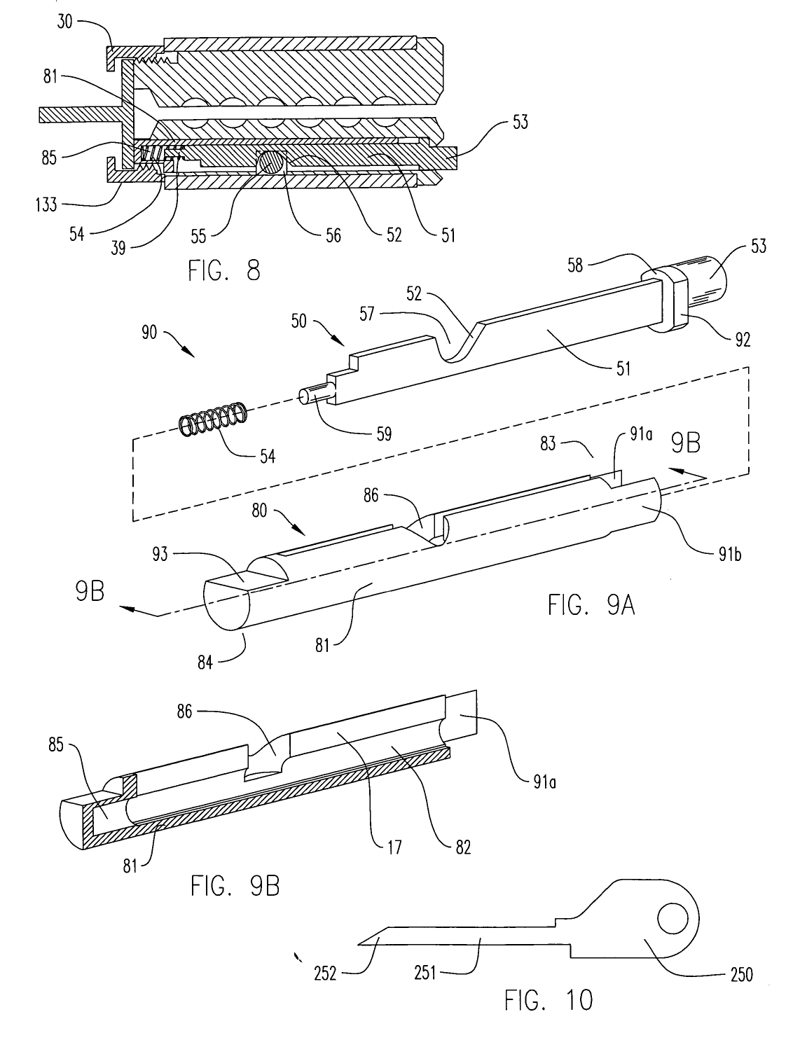

Shown in the illustrated embodiment in FIGS. 4 and 8 is a temporary retainer cavity 56, a temporary change member 55, and a change tool 50. As shown in FIGS. 8, 9A, and 9B, the change tool 50 is an integral change tool having a body 51 that has a cut-out recess 57 that registers with the temporary retainer cavity 56 when the change tool 50 is in its first position, and a lifting or biasing surface 52 disposed adjacent the recess 57, which can advance into the temporary retainer cavity 56 when the change tool 50 is manipulated into its second position for raising the temporary change ball 55 from the temporary retainer cavity. This embodiment of the change tool can have a head 53 that protrudes through an opening in the face 33 of the plug, for manipulating the change tool into its second position. A return spring 54 is disposed on and restrained by rear post 59 of the change tool 50, which biases the change tool blade away from the rearward end 133 of the plug to its first disengaged position. The head 53 of the change tool 50 is typically cylindrical and extends through a similarly-shaped and sized opening 35 formed in the face 33 of the plug 10. The opening 35 can be beveled outward toward the face 33.

The change tool 50 is disposed in a change slot 17 that can be formed or disposed within the plug 10, and is typically parallel to the axial centerline 200. The change tool 50 that is illustrated is formed integral with the plug of the lock, allowing the change tool to be associated with the plug during ordinary use. The change slot 17 typically extends from proximate, and in some embodiments through, the front face 33 and is formed proximate to the temporary retainer cavity 56. In the illustrated embodiment, the change slot 17 is formed beneath the periphery 12, and intersects with the temporary retainer cavity. The width and height of the change slot 17 are configured to accommodate a blade body 51 of the integral change tool 50. The radial depth of the change slot 17 is typically the same as the depth of the temporary retainer cavity 56, although it could have a depth slightly less that, or slightly greater than, the temporary retainer cavity 56. The configuration of the change slot 17 allows the beveled biasing surface 52 of the change tool 50 to move axially, by manipulation within the slot 17, from a first position (shown in FIG. 8) that is disengaged from the temporary change member 55 and out of intersection with the temporary retainer cavity 56, to a second position (shown in FIG. 14) that engages the temporary change member 55 and intersects with the temporary retainer cavity 56 to raise the temporary change member (hereinafter, the temporary change ball 55) at least halfway out of the temporary retainer cavity 56, where a centerline of the temporary change ball 55 is outside the retainer cavity 56 and beyond the periphery 12 of the plug. If the temporary change ball 55 is at least halfway out of the retainer cavity 56 when the change ball encounters a shear line, such as the edge 14 of the driver chamber 424 shown in FIG. 15, then the temporary change ball 55 will be forced out of the retainer cavity 56 and into the driver chamber 424. The change slot 17 is typically configured to minimize width, while maintaining effective lifting of the temporary change balls 55. The width of the illustrated change slot 17 is about 0.10 inches (about 2.5 mm), although widths greater, and preferably less, are usable. Alternatively, the change slot can be formed through the body of the plug, intersecting the periphery 12 of the plug.

One means for disposing the change tool integrally with the plug is shown in FIGS. 9A and 9B as a change tool assembly consisting of the integral change tool 50, return spring 54, and a slot dowel 80. The slot dowel 80 is shown as a cylindrically formed body having a longitudinal slot 17 formed in the length of the slot body 81 from the front end 83 to proximate the rear end 84. A circular counter bore 82 is also formed in the length of the slot body and overlaps the slot 17 to form a capture hole 85 for the return spring 54. A vertical bore 86 is formed intermediate the length of the slot 17 to register with the recess 57 in the change tool body 51 and the retainer cavity 56 formed in the periphery 12 of the plug.

The integral change tool 50 can be assembled separately, and installed into the plug. The return spring 54 is slid over the rear post 59, and the assembled spring 54 and change tool 50 are then slid rear-end first, fully into the slot 17 and counter bore 82, to form a change tool assembly 90. Referring to FIGS. 8, 9A and 9B, a longitudinal bore of substantially the same diameter as the slot dowel body 81 is machined parallel to the centerline of the plug just below the periphery 12 and intersecting the temporary retainer cavity 56. The change tool assembly 90 is then inserted front-end first into the longitudinal bore until the head 53 penetrates through the opening 35 in the face 33 of the plug. The threaded cap 30 then secures the change tool assembly. The off-set of the head 53 from the center of the shoulder 58 prevents the change tool 50 from rotating, while the mating of the prongs 91a and 91b of the dowel body 81 with the flats 92 on the shoulder 58 prevents the slot dowel 80 with slot 17 from rotating.

In alternative embodiments, the depressable (or conversely pullable) end of the elongated change tool can be configured proximate the rear end or face of the lock, for manipulation of the change tool from the rear of the plug. Such an embodiment of the integral change tooling is disclosed in co-pending U.S. Provisional Patent Application 60/656,355 (attorney docket EZL-006P), the disclosure of which in its entirety is incorporated herein by reference. The change tooling can also be configured wherein the protruding end of the change tool is pulled in order to manipulate it between its first and second positions. In another embodiment, the change tooling can have an engagement member in place of the protruding head, disposed inboard the front end of the plug, and exposed through the opening 35 in the plug face. An implement, such as the pin or staff, can be inserted through the opening to depress the engagement member for manipulating the change tooling. Typically the change tool is manipulated with a finger or hand, or an implement such as a pin, to move the elongated change tool rearwardly (or conversely forwardly).

Another embodiment of the means for displacing the temporary change member from the temporary change cavity is an integral change tooling that comprises a tool that is configured to rotate within the change tool slot. The rotating change tooling can comprise an elongated cylindrical member having a plurality of grooves formed along its length, in registry with the retainer cavities. The groove forms a void, within which the change member can be disposed, and will remain in the retainer cavity when the change tool is in the dis-engaged position. When the change tool cylinder is rotated to the engaged position, the biasing surface of the groove proximate the tool periphery engages the retainer cavity and displaces the change member out of the retainer cavity and into the driver chamber. A rotatable end for the rotating change tool can be manipulated with a finger or hand, or other implement such as a screw driver engaging a slot in the end, to rotate the rotatable change tool within the plug.

The temporary change ball 55 is typically positioned within the lock 1 in either a first position, disposed within the fourth pin chamber between the driver 427 and the tumbler 425, or in a second position within the temporary retainer cavity 56 (shown in FIG. 3). During operation of the lock and in response to the reprogramming of the lock for use with a temporary user key, such as the temporary first user key 140t shown in FIG. 7, the temporary change ball 55 can be moved from its second position in the retainer cavity 56 to its first position in the fourth pin chamber.

The lock 1 is associated with a set of keys 40, a subset portion of which is illustrated in FIG. 7. The subset of keys 40 can include a first main user key 140, a second main user key 240, a third main user key 340, and a fourth main user key 440. Each of the main user keys has a shaft portion 47 having an upper contour edge that comprises a plurality of contour landings 48 that define a plurality of contour positions. In the illustrated embodiment, each contour position corresponds to one of the pin chambers of the lock. Each contour landing 48 is generally flat and parallel with the axis of the key shaft 47. When any of the keys 40 are inserted fully into the keyway 11 of the plug 10, the contour positions 1 through 6, identified as contour positions 41, 42, 43, 44, 45, and 46, align with the pin chambers 1 through 6 of the lock. The shaft 47 of a key 40 can be formed or machined to a specific depth at each contour position. The length of each contour landing 48 should be sufficiently long to prevent a tumbler 25 from beginning to descend prematurely off the end of the contour landing 48 when inserting or withdrawing the key 40 from the keyway 11. At the same time, the sloped transition portions 49 between adjacent contour landings 48 should be sufficiently shallow in slope to allow the plurality of positioned tumblers 25 to run up and down the length of the contour of a key 40 as the key is being inserted into (or removed from) the keyway 11.

As is well known in the lock industry, the depth of a contour is typically made in relation with the height of the tumbler in the corresponding pin chamber. In the present invention, the depth of the cut (or said differently, the height) of the contour in contour positions 1, 2 and 3 is also made in relation to the height (diameter) of the main change balls 126, 226 and 326 associated therewith. If a main user key is intended to raise a particular main change ball 26 above the shear line 19 of a pin chamber, then the corresponding contour position of that main user key should be cut to a shallow depth (a raised contour), which can raise the main change ball 26 above the shear line 19. In the illustrated embodiment, each main user key 140, 240, 340, and 440 can comprise one, two, or more raised contours, two of which are shown as phantom lines 61a and 61b, or one, two or more lowered contours 62a and 62b, or a combination of raised and lowered contours. The height of a particular contour position from among the first three contour positions 41, 42 and 43 will indicate each key's ability to raise one or more of the main change balls 26 above the shear line 19. For example, key #1 (140) has a deep cut (a lowered contour 61) at each of the first three contour positions, meaning that key 140 cannot raise any of the three main change balls 126, 226 or 326, above the shear line 19. Key #2 (240) has a shallow cut (a raised contour 62) in the first contour position 41, and deep cuts (lowered contour 61) in the second and third contour positions 42 and 43, meaning that key 240 will raise only main change ball 126 above the shear line. The third key 340 has shallow cuts (raised contour 61) in the first and second contour positions 41 and 42, and a deep cut (lowered contour 62) in the third contour position 43, meaning that the key 340 can raise main change balls 126 and 226 above the shear line. The fourth key 440 has only shallow cuts (raised contours 61) in the first 41, second 42 and third 43 contour positions, meaning that key 440 can raise main change balls 126, 226 and 326 above the shear line.

In the description above, it should be understood that a key configuration that raises the main change ball 26 above the shear line 19 is also raising the top end of the tumbler 25 to the shear line. This ensures that the main change ball is displaced into the driver chamber 24, and that no hardware member in the pin chamber spans the shear line so that the plug can rotate within the housing.

The operation of the lock of the first embodiment will now be illustrated. First, the lock is described in its operation with a first main user key 140, and in the use of a temporary user key 140t associated with the first user key 140.

FIG. 4 shows the lock in a configuration wherein the lock is operable with the first main user key 140. FIG. 5 shows the lock of FIG. 4 with the first main user key 140 inserted into the keyway 11. In this lock configuration, main change ball 126, 226 and 326, corresponding to the first, second and third pin chambers are positioned within the pin chamber between the corresponding tumblers 125, 225 and 325, and drivers 127, 227 and 327. The main retainer cavities 116, 216 and 316 are empty. The temporary change ball 55 is disposed in the temporary retainer cavity 56.

As shown in FIG. 5 when the first main user key 140 is inserted into the keyway 11, the contour positions 1 through 6 of the key 140 raise corresponding tumblers 25 within the pin chambers. In pin chambers 4, 5 and 6, the corresponding tumblers 425, 525 and 625 lift the bottom end of the corresponding driver 427, 527 and 627 to the shear line 19, as shown in FIG. 6. In pin chambers 1, 2, and 3, the corresponding tumblers 125, 225 and 325 raise both the corresponding main change balls 126, 226 and 326 and the corresponding drivers 127, 227 and 327, whereby the lower or bottom edge of each of the drivers 127, 227 and 327 is aligned with the shear line 19. (It can be seen that the bottom edge of the drivers and the top edge of the tumblers can be slightly beveled to assist aligning the drivers or tumblers with the shear line.) Thus, the lower end of each of the drivers 27 in pin chambers 1 through 6 has been raised to the shear line 19. The main change balls 126, 226 and 326 are retained below the shear line 19 and within the tumbler chambers 113, 213, and 313 of the plug.

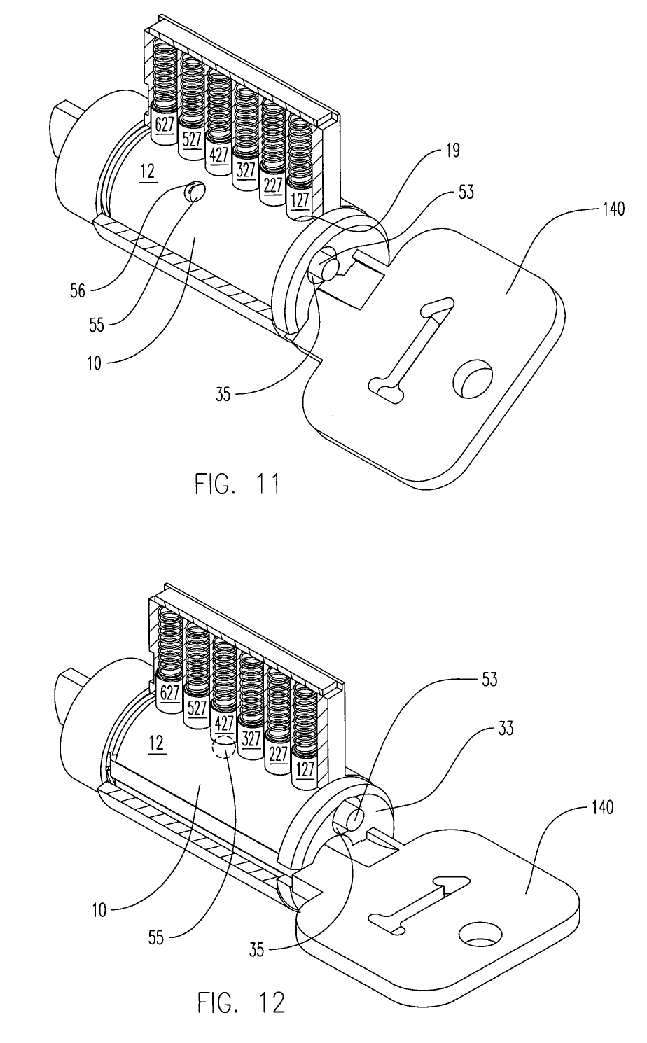

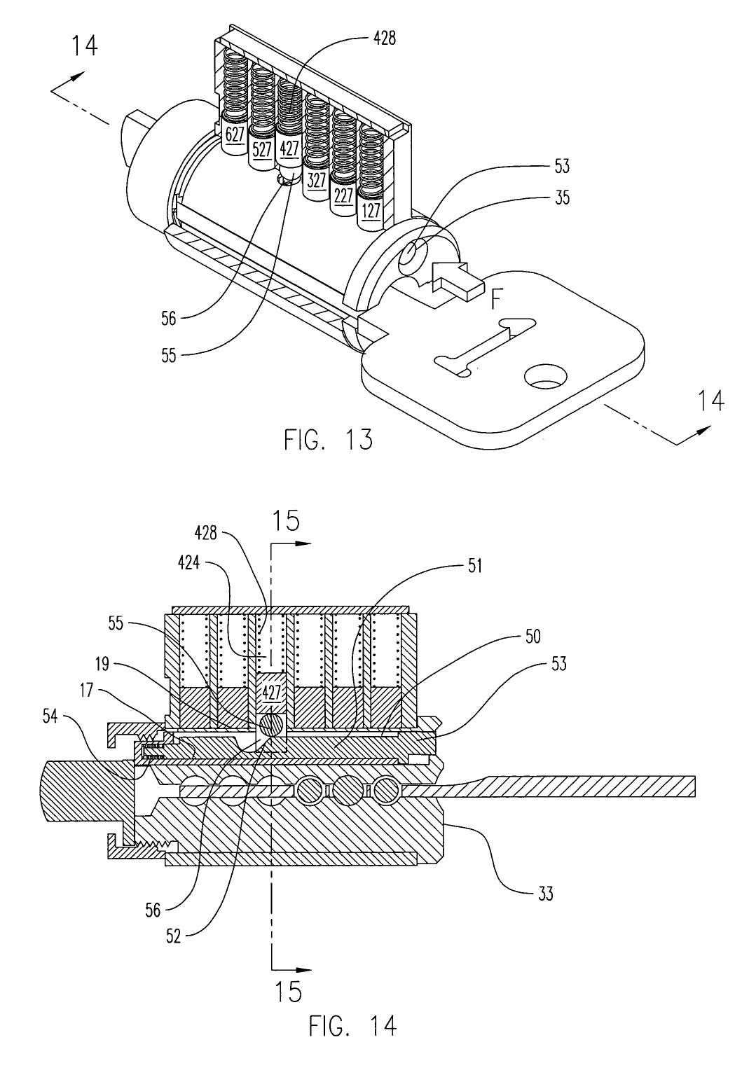

As shown in FIG. 11, as the user key 140 is rotated clockwise (when facing the lock from the key side), the plug 10 can rotate within the bore of the housing from its first rotated position shown in FIG. 5, toward a second rotated position shown in FIG. 12. The second rotated position of the plug can be the unlock position of the lock, or the locking position of the lock. For the purposes of this embodiment, the second rotated position (FIG. 12) is the unlock position. The second rotated position is also the temporary programming position, which is described herein after. Each of the drivers 127, 227, 327, 427, 527 and 627 in pin chambers 1 through 6 will ride along the outer periphery 12 of the plug 10 as the plug is rotated toward its second rotated position. Rotation of the plug 10 to its second rotated position shown in FIG. 12 opens or unlocks the latch associated with the lock.

It can be understood that the plug 10 can be rotated in the opposite direction back to the first rotated (or key insertion) position (shown in FIG. 5), and from that position, rotated further in the opposite direction to a third rotated position, which would close or lock the associated latch, and back. The first main user key 140 in the first rotated position can be withdrawn and reinserted as desired by the user.

FIGS. 11 through 19 show reprogramming of the lock for operation with a temporary user key 140t associated with the first user key 140. FIGS. 11 and 12 shows the first user key 140 inserted and the plug being turned to its second rotated position, as termed the temporary programming position. In this position, the temporary retainer cavity 56 and change slot 17 are aligned with the driver chambers 24 of the housing 12. As can be seen in FIG. 11, the temporary change ball 55 is positioned within the temporary retainer cavity 56, and the change tool 50 is in its first position in the slot 17, disengaged from the temporary change ball 55 in the temporary retainer cavity 56, with the head 53 protruding through the opening 35 in the face of the plug 10.

FIGS. 13 and 14 illustrate the full insertion of a change tool 50 to its second position, where the leading edge 52 of the integral change tool 50 displaces the temporary change ball 55 out of the temporary retainer cavity 56. The displaced temporary change ball 55 is pushed at least partly into driver chamber 424 below the driver 427, compressing the driver spring 428 above the driver 427. The illustrated embodiment shows that the change tool 50 is inserted by pressing inward on the head 53 with a force F, compressing the return spring 54 and causing the leading edge 52 to intersect the temporary retainer cavity 56. The head 53 is typically depressed with a finger or thumb of the person manipulating the key.

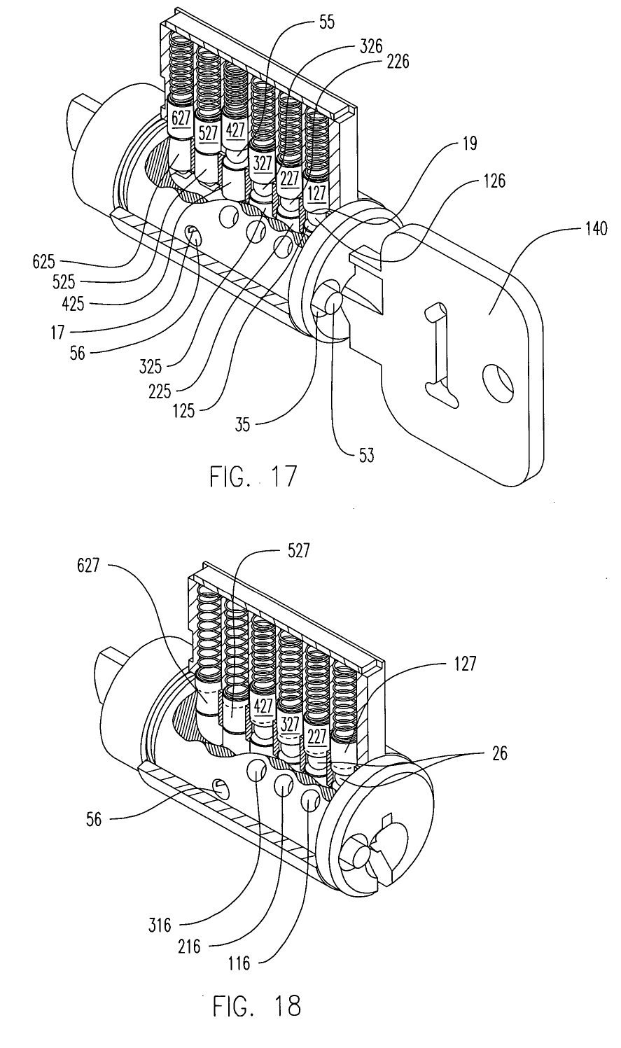

With the change tool 50 fully inserted to its second position, the plug with first main user key 140 is rotated back toward the first rotated position. The temporary change ball 55 has been moved and isolated into the driver chamber 424 of the fourth pin chamber between the driver 427 and the periphery 12 of the plug, as shown in FIG. 16. Once the plug has been rotated away from its second rotated position, and the temporary change ball has been isolated in the driver chamber, the force F on the change tool 50 can be released, allowing return spring 54 to return the change tool to its first position. The head 53 protruding through the opening 35 in FIG. 17 evidences this. When the plug is rotated back to its first rotated position shown in FIG. 17, the temporary change ball 55 is positioned in its first position within the fourth pin chamber, between the tumbler 425 and the driver 427.

FIG. 18 shows the lock configured for temporary operation with temporary first user key 140t after the first main user key 140 has been withdrawn. Thus, the lock is configured for operation with a temporary user key when the temporary change ball 55 is disposed in its first position in the temporary pin chamber.

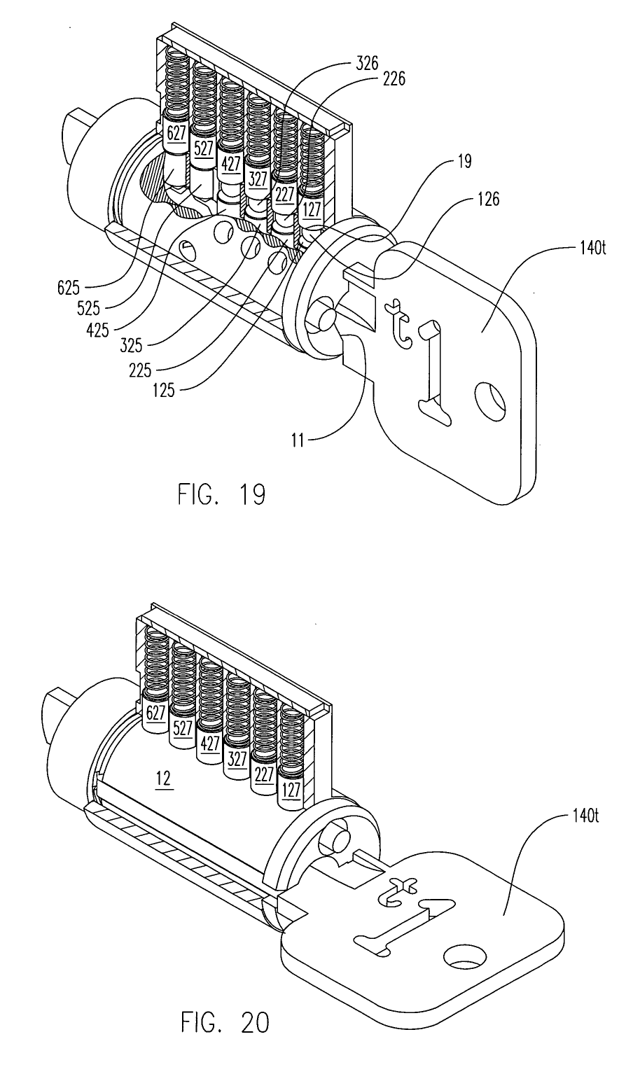

As shown in FIG. 19, when the temporary first user key 140t is inserted into the keyway 11, the lowered contours of contour positions 1 through 4 raise the tumblers 25, main change balls 26, temporary change ball 55, and drivers 27, so that the bottom end of the drivers 127, 227, 327 and 427 align with the shear line 19. The main change balls 26 and the temporary change ball 55 are positioned in the tumbler chambers, below the shear line 19. As the plug 10 is rotated with the inserted temporary first key 140t, the main change balls 26 and the temporary change ball 55 remain in the tumbler chambers of the plug. FIG. 20 shows the lock when the plug has been operated with the temporary user key 140t and rotated to the second, or unlock, position, with the drivers 27 riding along the periphery 12 of the plug 10. Though not shown, the plug 10 can also be rotated in the opposite direction to the third rotated position or the lock position with the temporary user key 140t.

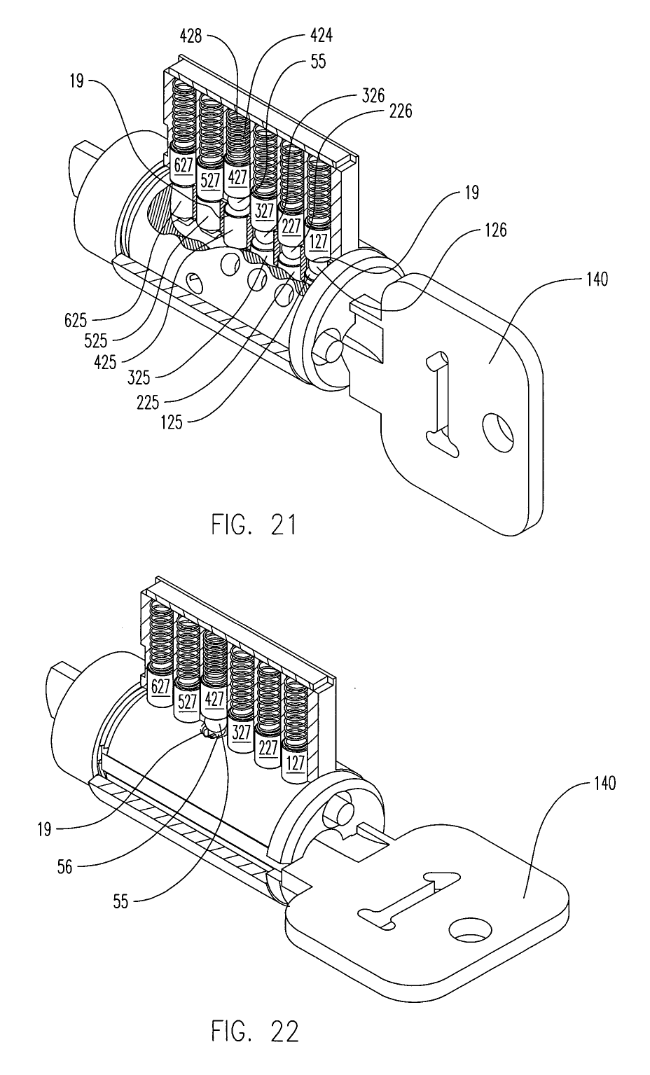

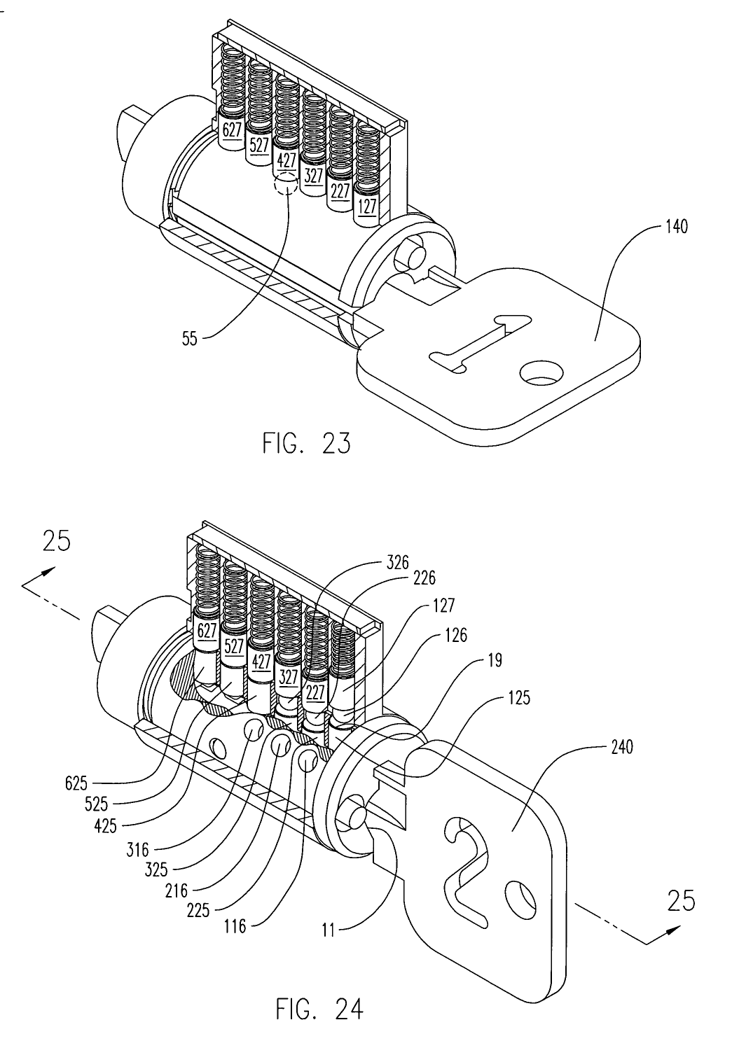

When the temporary use of temporary user key 140t is deemed finished, the lock in the illustrated embodiment can automatically be reconfigured to cancel or disable operation of the temporary user key 140t, and to restore operation to the first main user key 140. As shown in FIG. 21, with the lock configured for operation with the first temporary user key 140t, the original first user key 140 is inserted into the keyway 11. As shown, the raised contour of the fourth contour position 44 of key 140 (see FIG. 7) raises the temporary change ball 55 above the shear line 19 and at least halfway into the driver chamber 424. When the plug is rotated toward the second rotated position, the temporary change ball 55 becomes isolated in the driver chamber 424. FIG. 22 shows the driver 427 and temporary change ball 55 frozen in position, for illustration purposes, as the plug 10 arrives at the second rotated position. In real time, as the plug 10 approaches the second rotated position, the temporary change ball 55, which is being biased by the driver 427 and driver spring 428 toward the shear line 19, will be driven into the temporary retainer cavity 56, as shown in FIG. 23. The lock has thus been restored to a configuration that allows operation with the first main user key 140 but that does not allow operation with the first temporary user key 140t. When the plug 10 and first user key 140 are rotated back to its first rotated position, they will appear as they do in FIG. 5.

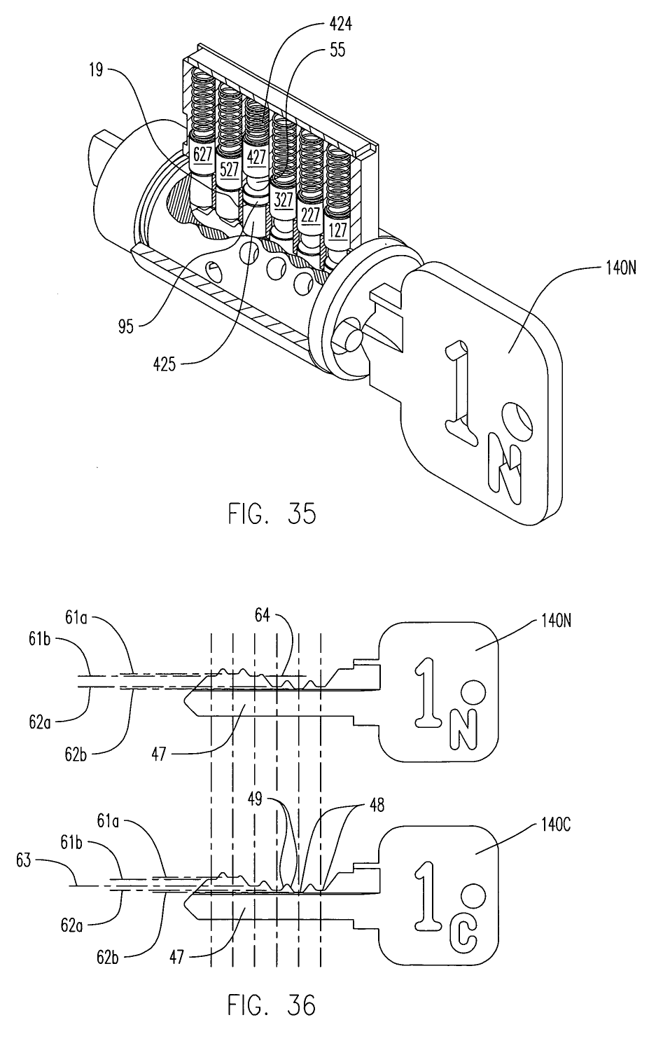

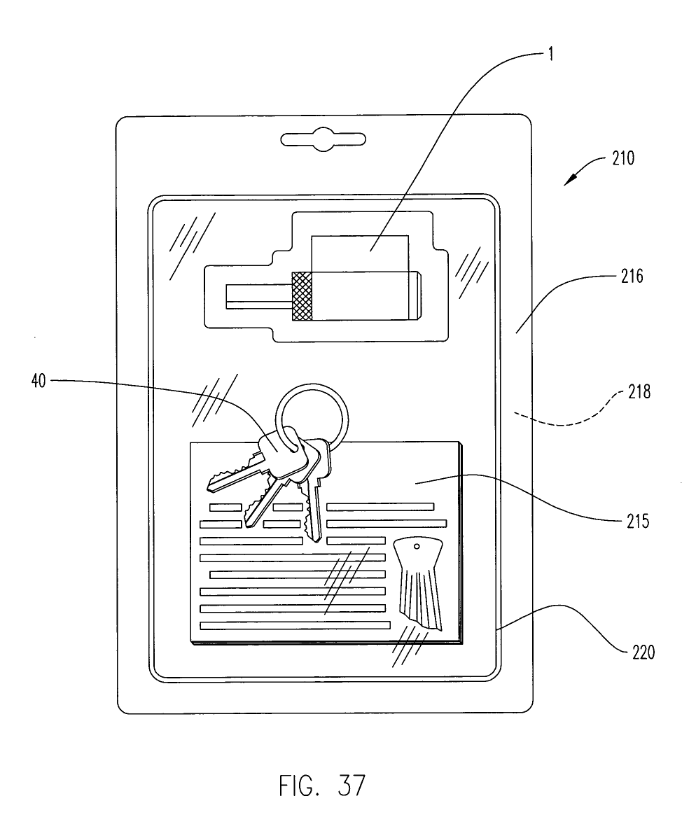

In an alternative embodiment, as described herein before, a non-canceling main user key can be used while the lock is in the temporary lock configuration, without moving the temporary change member back to the temporary retainer cavity. FIG. 35 shows an embodiment where a mastering shim 95 is disposed below the temporary change ball 55 in the temporary pin chamber. Non-canceling first main user key 140N, shown in FIG. 36, has a fourth contour position 44 that has an upper contour 64 that is higher (shallower cut), by the depth of the mastering shim 95, than the contour 63 of the ordinary or canceling first main user key 140C. The higher contour 64 enables the non-canceling first main user key 140N to raise the mastering shim 95 above the shear line 19, whereas the lower contour 63 of the canceling first user key 140C can hold the mastering shim 95 below the shear line. The higher contour of the non-canceling key 140N raises the mastering shim 95 with the temporary change ball above shear line 19 and into the driver chamber 424. When the plug is rotated with the non-canceling first main user key 140N to the temporary programming position (not shown), the mastering shim 95, which is slightly larger in size than the opening to the temporary retainer cavity, blocks the temporary change ball from leaving the driver chamber. Thus, operation of the lock in the temporary programming configuration with the non-canceling main user key does not cause automatic reprogramming of the lock.

It can be understood that the lock can be reprogrammed for temporary operation with temporary first user key 140t as many times as the user desires. Each time, the temporary configuration of the lock can be cancelled by reinserting the operable first main user key 140 and rotating the plug of the lock to the first rotated position, which moves, solely by rotation of the plug, the temporary change ball from its first position in the temporary pin chamber, back into its second position in the temporary retainer cavity.

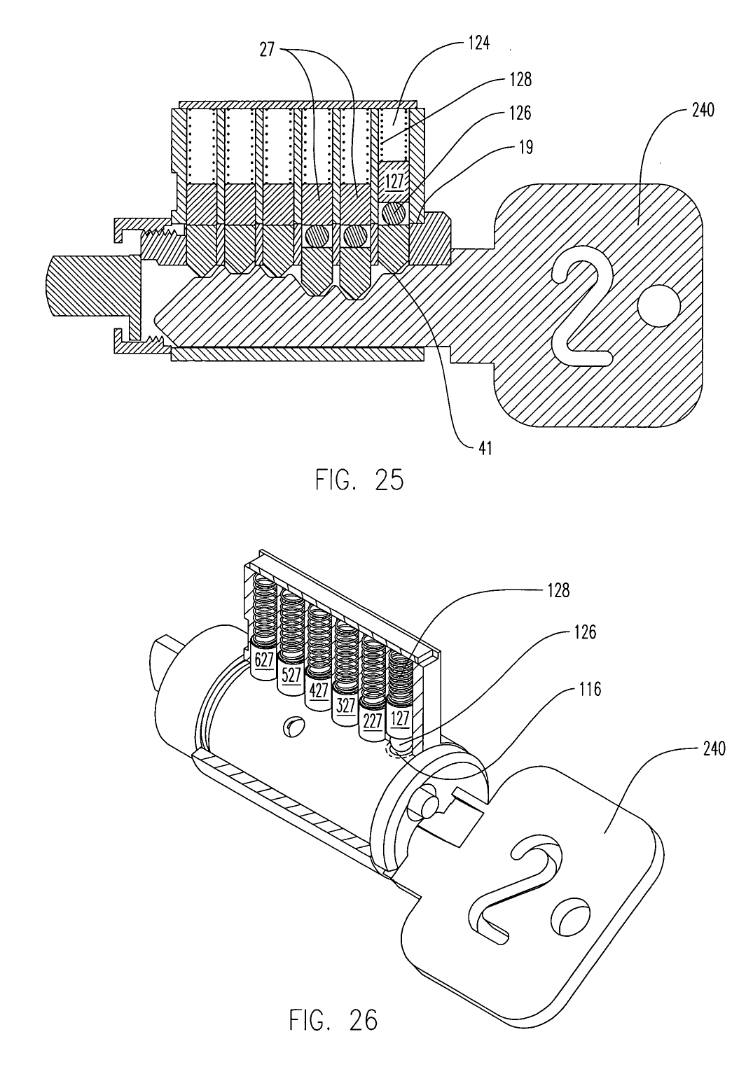

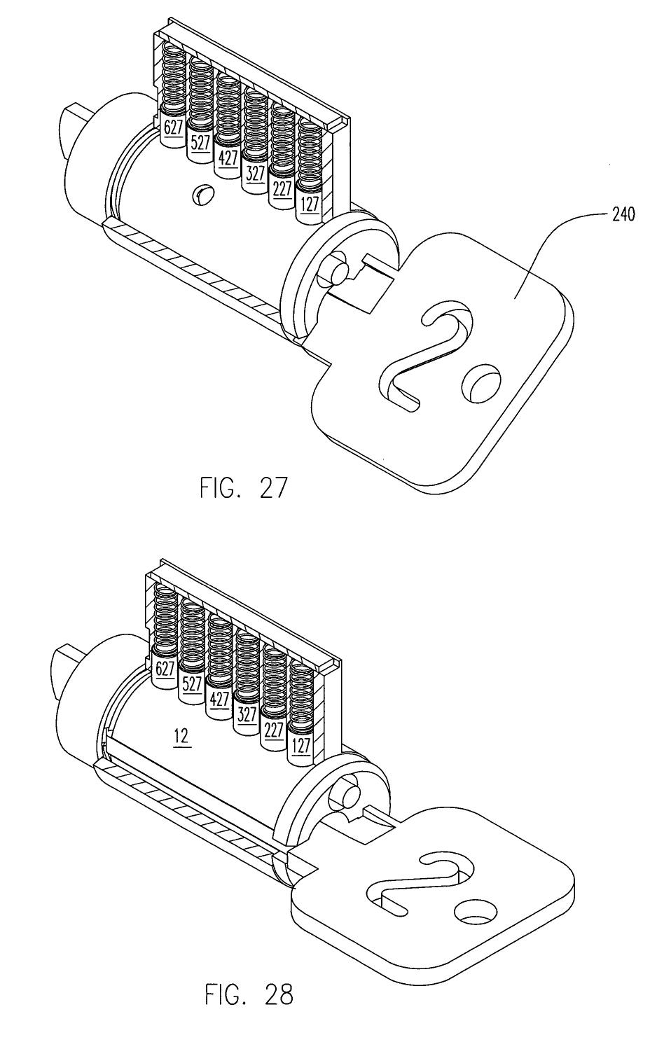

At some time, the first temporary user key 140t or the first main user key 140 may be lost, stolen, or misplaced, whereby the security and exclusive use of the lock by the intended user or owner may be compromised. Or, the home or object in which the lock is installed may be sold or transferred to another person. In such case, or at any time desired by the user, the lock can be configured for operation with the second main user key 240. As shown in FIG. 24, the second main user key 240 is inserted into the keyway of the plug, which is shown configured for operation with the first user key 140, and has each of the main change members 126, 226 and 326 disposed in the respective first, second, and third pin chambers. As shown in FIG. 25, the raised contour (61b) of the first contour position 41 of the second user key 240 raises the first main change ball 126 above the shear line 19 and into the driver chamber 124. As with the first main user key 140, the second main user key 240 raises the lower end of all remaining drivers 27 to the shear line 19. As the second main user key 240 rotates the plug toward the second rotated position, the first main change ball 126 remains captured in the driver chamber 124 until the plug 10 arrives at a fourth position, or main programming position, where the plurality of main retainer cavities 116, 216 and 316, shown in FIG. 24, align with the driver chambers 24, shown in FIG. 26. FIG. 26 shows the driver 127 and change ball 126 frozen in position, for illustration purposes, as the plug 10 arrives at the main programming position. In real time, as the plug 10 approaches the main programming position, the first main change ball 126, biased by the driver spring 128, will be driven into the main retainer cavity 116, as shown in FIG. 27.

Typically, and in the illustrated embodiment, the main change ball 126 can not be removed from the main retainer cavity 116 unless the lock is disassembled, such that their movement to the main retainer cavities is essentially irreversible. In an alternative embodiment of the present invention, an independent means can be used for displacing the main change balls from their retainer cavities and back into the pin chambers. A provided main change tool can be disposed within a provided main change slot that intersects the main retainer cavities, and with a plurality of biasing members disposed along the main change tool. Manipulation of the main change tool can cause the plurality of biasing members to move between a first position out of engagement with the main retainer cavities, and a second position into engagement with the main retainer cavities. Manipulation of the main change tool from the first position to the second position allows movement of the main change balls from their corresponding retainer cavities and back to the pin chambers. An embodiment of a main change tool for displacing change members from the retainer cavities and back into the pin chambers is disclosed in U.S. Patent Application Publication 2004/0221630, the complete disclosure of which is hereby incorporated by reference.

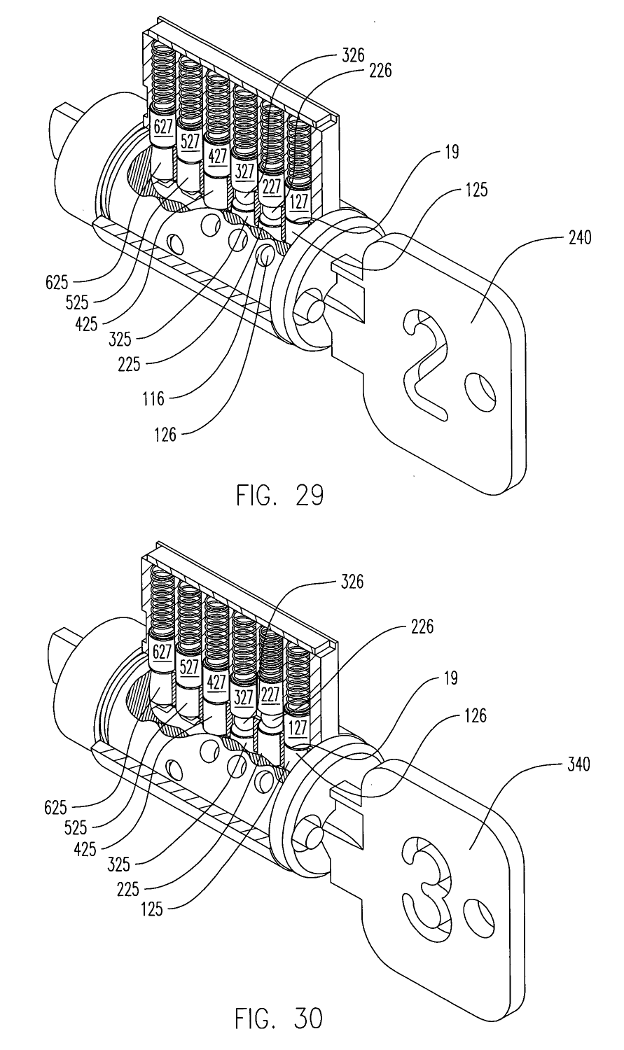

FIG. 28 shows the plug 10 rotated by the second main user key 240 to the second rotated position. It can be noted that the driver 427 has a diameter wider than that of the temporary retainer cavity 56, and can not impede rotation of the plug by engagement therewith. The change tool 50 is also disposed within the change slot so that it does not project above the periphery 12 of the plug. FIG. 29 shows the plug 10 and second main user key 240 rotated back to the first rotated position. The lock is now configured for operation with the second user key 240. The main change ball 126 in the first pin chamber has been moved to the first main retainer cavity 126, and is no longer in the first pin chamber. Though not illustrated, it can be understood that the lock shown in FIG. 29 will not operate with the first main user key 140, since, without the main change ball 126 in the first pin chamber, the lowered contour of the first contour position 41 of the first user key 140 cannot raise the bottom end of the first driver 127 to the shear line 19, whereby the body of the driver 127 spans the shear line and blocks rotation of the plug within the housing.

In a similar way, the lock can be configured for operation with the third main user key 340, shown in FIG. 30 inserted into the lock while the lock is configured for operation with the second main user key 240, and subsequently with the fourth main user key 440, by merely inserting the next main user key in the series into the lock and rotating the plug to the main programming position. The third main user key 340 has raised contours 61 in the first 41 and second 42 contour positions. When the main user key 340 is inserted into the keyway 11, the raised contours raises the second main change ball 226 above the shear line 19 and into their respective driver chamber 28. Upon turning the plug 10 with the third main user key 340, the main change balls 126 and 226 will have been moved from the driver chambers 124 and 224 into their respective main retainer cavities 116 and 216, thereby programming the lock for operation with the third main user key 340 and disabling operation with both the first user key 140 and the second user key 240. In a similar fashion, the lock can be programmed for operation with the fourth main user key 440, which disables operation with all of the first 140, second 240, and third 340 user keys.

It can be understood that when the lock is configured for operation with the first user key 140, the third user key 340 can be inserted into the plug and the plug rotated to the main programming position, thereby programming the lock configuration for operation with the third main user key. The second user key 240 has been skipped in this case. Since the third user key 340 can move the main change balls 126 and 226 into their respective main retainer cavities 116 and 216, neither the first main user key 140 nor the second main user key 240 will operate the lock when configured for the third main user key 340. Thus, the user of any successive main user key in the series of user keys 40 bypasses operational configurations of the lock for preceding user keys.

When configured for operation with any one of the main user keys 240, 340 or 440, the lock can be reprogrammed for temporary operation with a corresponding second temporary user key, third temporary user key and fourth temporary user key, as described above and in FIGS. 13-19 for the first temporary user key 140t. Each of the second, third and fourth temporary user keys has a contour edge that is the same as its respective main user keys 240, 340 and 440, except that the temporary user keys have a lowered position at the fourth contour position 44 (associated with the temporary pin chamber 418), whereas the corresponding contour position of the main user keys have a raised position. With the lock configured for temporary access by a temporary user key (that is, when the temporary change ball is positioned within the temporary pin chamber), the lock can be operated by a temporary user key that is associated with any succeeding main user key.

The illustrated embodiment in FIGS. 1-6 shows a lock having the main retainer cavities 16 and their corresponding main change balls 26 associated with pin chambers 1 through 3, and having the temporary retainer cavity 56 and the temporary change ball 55 associated with the fourth pin chamber, and having conventional fifth and sixth pin chambers that do not have an associated retainer cavity and change ball. The arrangement of the main retainer cavities, temporary retainer cavity, and the associated main and temporary change members can assume any arrangement within the plug. In an embodiment of the lock where the temporary programming pin chamber is disposed forward in the first or second pin chamber positions, the temporary change tool can be configured to position the return spring rearward from the temporary retainer cavity, with the beveled edge lying intermediate the return spring and the head end. Various designs of the integral change tool can be realized.

In a preferred embodiment, the sixth pin chamber has neither a main retainer cavity nor a temporary retainer cavity associated therewith. By using the sixth pin chamber as a conventional pin chambers, incidental keying is reduced. Incidental keying can occur when a user key is slightly withdrawn from the keyway, and then turned to rotate the plug. When slightly withdrawn by, for example, about one-half the length of a contour landing, it is possible that a change ball sitting on a lowered contour may be raised upward within the tumbler chamber by a sloped transition portion. If the centerline of the change ball is raised just slightly above the shear line, then rotation of the plug can cause the top edge of the tumbler chamber to force the change ball out of the tumbler chamber and into the driver chamber. Upon full rotation of the plug, the unintentionally displaced change ball will be deposited into its corresponding retainer cavity, thereby reprogramming the lock to a different configuration. When the very same user key is then reinserted fully, it will not operate the lock, since the displaced change ball is missing from the stack in the pin chamber, and the driver will not be raised up sufficiently above the shear line, so that it spans the shear line. In this embodiment, the user keys can be configured so that, when the key is initially withdrawn from the keyway, the sixth pin chamber will be the first chamber where the hardware (the tumbler and the drivers) will fall off the end of the key and span the shear line 19, thereby preventing any rotation of the plug in the housing and preventing incidental keying.

In an alternative embodiment, the temporary retainer cavity 56 can be disposed on the opposite side of the plug from the one or more main retainer cavities 26. In one embodiment, the temporary retainer cavity 56 can be positioned as illustrated in FIG. 3, and aligned with the driver chambers when the plug is rotated clockwise to the second rotated position, while the configuration retainer cavities 26 can be disposed on the opposite side of the plug 10, and aligned with the driver chambers when the plug is rotated counter-clockwise toward the third rotated position. The programming of the lock from one main user key to the next occurs as the key is rotated toward the locking position. In other embodiments, the positioning of the temporary retainer cavity and the main retainer cavities can be reversed on opposite sides, or can be on the same, but opposite side of the plug.

In another embodiment, the line of main retainer cavities can be circumferentially displaced from the tumbler cavities by between about 20 degrees to about 70 degrees, provided that the openings of the main retainer cavities do not overlap those of the tumbler chamber or the temporary retainer cavity. Alternatively, the main retainer cavities can be disposed more than 90 degrees, more typically between about 110 degrees to about 160 degrees, from the aligned tumbler chambers. This would require the plug be rotated almost completely before the user configuration of the lock can be changed by the next user key in the series.

It can be understood that the lock assembly of the present invention can comprise more (4 or 5) or less (1 or 2) main user keys than depicted in the first embodiment.

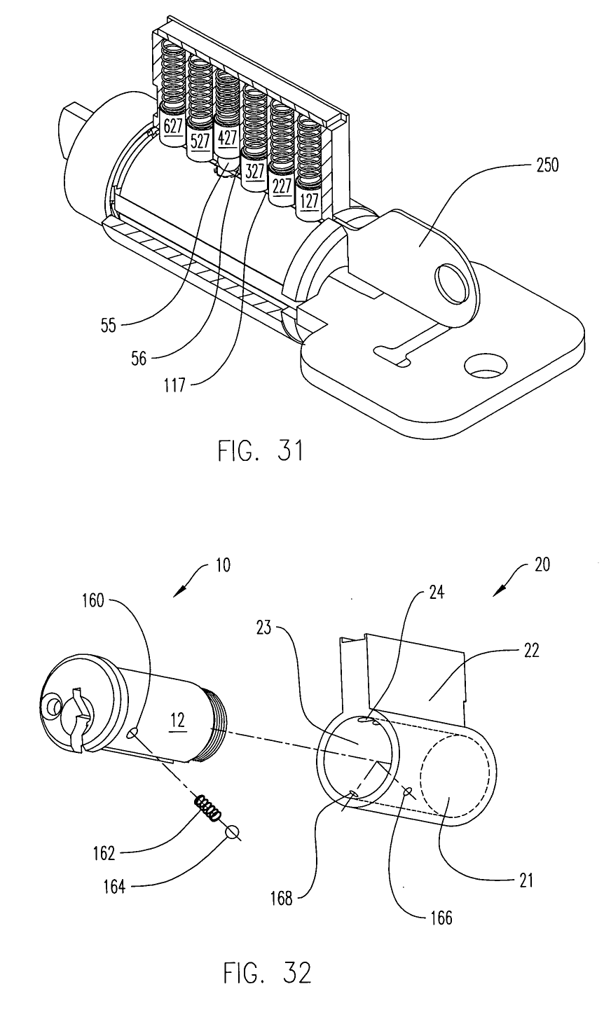

A second embodiment of the present invention is similar to the first embodiment, where instead the lock has a separate change tool 250 that can be manually inserted and withdrawn from the change slot when needed to raise the temporary change ball 55 out of the temporary retainer cavity 56. As shown in FIG. 31, the change slot 117 of this embodiment can have a narrow width to accommodate the blade 251 of the separate change tool 250 shown in FIG. 10. The change slot 117 of the illustrated embodiment is typically configured with a minimum width, while maintaining effective lifting of the temporary change balls 56. The width of the change slot 117 is typically about 0.020 inches (about 0.50 mm) or less. The change slot 117 can be formed into the body of the plug, either through at least a portion of the periphery, or within the periphery, of the plug.

The blade 251 is configured for insertion through the change slot 17, and has a tapered leading edge 252. When the plug has been rotated to the temporary programming position, the change tool 250 can be inserted into the length of the change slot 117 to raise the temporary change ball 55 from the temporary retainer cavities 56, into the corresponding driver chamber. When the plug has been rotated away to isolate the temporary change balls 55 in the driver chamber, the change tool 250 can be withdrawn from the change slot 117.

Typically the change slot 117 can be formed or machined along a majority of, and preferably the entire length of, the plug 10, to ensure that the corresponding change tool 250 will be stably retained in the slot 117 upon insertion. Therefore, even when the temporary retainer cavity 56 is associated with the first or second pin chamber, it is typical to machine the change slot 117 from the front face 33 to the full length of the plug, so that when the change tool 250 is inserted, it will not readily tilt or fall out.

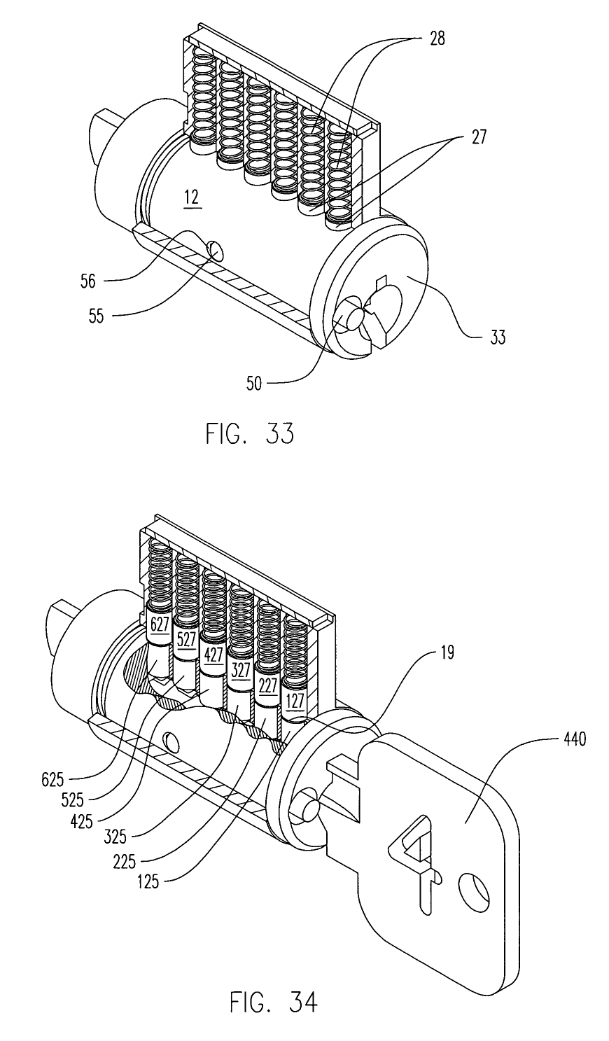

A third embodiment of the present invention is shown in FIGS. 33 and 34. This embodiment shows the programmable lock that is configured for operation by a single main user key, and which is programmable for temporary operation by a temporary user key. The lock is shown in FIG. 33 having a temporary retainer cavity 56, an integral change tool 50 disposed in a temporary change slot (not shown), and a temporary change member 55 disposed in the temporary retainer cavity 56. In contrast to the first embodiment of the lock, the third embodiment does not have a main retainer cavity or a main change member, which had provided the earlier embodiment with the capability of programming the lock for operation with additional main user keys. The present embodiment provides a single main user key, illustrated as user key 440 in FIG. 34, which when inserted into the lock, can raise the top ends of the plurality of tumblers 125, 225, 325, 425, 525, and 625 (and consequently the bottom ends of the plurality of drivers 127, 227, 327, 427, 527, and 627) to the shear line 19 for rotation of the plug 10. Main user key 440 is shown in FIG. 7. The fourth main user key 440 is chosen to illustrate this embodiment since it was configured, in the context of the first embodiment and in the present embodiment, to operate the lock when none of the pin chambers contains a main lock configuration change member. As described hereinbefore for the first embodiment, this embodiment can also comprise a temporary user key (not shown) associated with the fourth main user key 440. The temporary user key (which will be denoted for convenience as 440t) will have a contour edge that is similar to the contour edge of the fourth main user key 440, except that in the fourth contour position 44, the temporary user key 440t has a lowered contour, whereas that of the fourth main user key 440 has a raised contour position. As described herein before and at FIGS. 11 through 20, the lock of the present embodiment can be configured for temporary access by the temporary user key, by rotating the plug with the operable main user key to the temporary programming position, manipulating the change tool to move the temporary change member out of the temporary retainer cavity and into the corresponding driver chamber, and then rotating the plug back to the key insertion position. In this configuration, with the temporary change member isolated in the temporary pin chamber, the lock can be operated by the temporary user key 440t. As described in the first embodiment and illustrated in FIGS. 21-23, the operation of the lock by the temporary user key can be cancelled by reinserting and rotating the plug with operable main user key 440 to the temporary programming position. This action will cause the temporary change member disposed in the fourth pin chamber to be raised above the shear line, and then deposited back into the temporary retainer cavity when the plug is rotated. In this embodiment, a lock kit would include the lock, the main user key, and the temporary user key.

Another embodiment of the present invention, shown in FIG. 39, further provides a lock kit 201, comprising a) a programmable lock assembly 1 according to any of the lock embodiments of the invention; b) a set of keys 40 comprising at least one main user key and at least one temporary user key associated with the programmable lock assembly; c) instructions 215 for use of the set of keys in the programmable lock assembly; and d) a means for securing together the set of keys, programmable lock assembly, and the instructions. The instructions 215 typically will describe use of the user key to program the lock for use with the temporary key, for operation of the change tooling, for cancellation of the operation of the temporary key, and for use of any second or other user lock. The kit 201 typically uses a first and second laminate 216 and 218 of a plastic sheet between which the lock, keys and instructions are secured, typically with a crimp 220 that holds the elements in place and prevents them from coming out of the kit.

In another embodiment of the present invention, a method is provided for using the lock by providing a means for rapidly changing the internal configuration of the drivers, tumblers and change balls of the lock to program the lock to operate temporarily with a temporary user key of a set of user keys. The temporary user key is associated with a main user key for which the lock is presently configured. The method of using the rapidly-programmable lock does not require disassembly, or removal of the plug from the housing. The method involves inserting operable first user key into the keyway of the lock. The method includes the step of rotating the first user key to rotate the plug to the temporary programming position, where the temporary retainer cavity aligns with its corresponding driver chamber. The next step is the inserting of the change tool into the change slot, and displacing the temporary change ball from the temporary retainer cavity into the driver chamber. The method includes the step of rotating the plug in an opposite direction to the first rotated position, and withdrawing the change tool from the change slot, whereby the temporary change ball is disposed in the pin chamber associated with the temporary retainer cavity. The lock will now operate with the temporary user key. The method includes the additional step of inserting the original user key into the keyway. This results in the raising of the temporary change ball out of the tumbler chamber, to above the shear line and into the driver chamber. An additional step includes rotating the plug to its second rotated position, which results in the temporary change ball being moved from the driver chamber into the temporary retainer cavity, now aligned below the driver chamber.

In another embodiment, the lock can be provided with a means for signaling to the user that the key and plug are in the first rotated position (or the key insertion position). A typical plug positioning means is a detent and pin. As shown in FIG. 32, the periphery 12 of the plug 10 is provided with a first detent cavity 160, typically a rounded or cylindrical hole that penetrates partially into the body of the plug. A detent pin, shown as a detent ball 164, is disposed in the first detent cavity 160, and is biased radially outward toward the shear line or periphery of the plug by a biasing means, shown as a detent spring 162. A second detent cavity 166 is disposed in the inner surface 23 of the bore of the barrel portion 21 of housing 20, and is shown in FIG. 32 as a hole formed through the barrel portion 21. The detent means is configured such that the first detent cavity 160 and the second detent cavity 166 align and register with one another when the tumbler chambers 13 in the plug 10 are aligned with the driver chambers 24 of the housing 20. The second detent cavity 166 has a size or diameter less than the size or diameter of the detent ball 164, such that when the first and second detent cavities are aligned, the detent ball is retained partially within the first detent cavity 160 and partially within the second detent cavity 166. Typically, the first detent cavity 160 is formed on the side of the plug 10 opposite the retainer cavities 16. The first detent cavity 160 is also typically disposed in the plug 10 longitudinally displaced from any of the retainer cavities 16 and the temporary retainer cavity 56. This ensures that the first detent cavity 160 cannot register or align with any of the retainer cavities 16, the temporary retainer cavity 56, or driver chambers 24 when the plug 10 is rotated fully within the housing 20. This arrangement avoids interference between the operation of the plug positioning means with the movement of a change ball 26 between a driver chamber 24 and a retainer cavity 16, or of a temporary change ball 55 between the temporary driver chamber and the temporary retainer cavity 56.

In operation, when the plug is in its first rotated position, as shown in FIG. 3, the first detent cavity 160 and the second detent cavity 166 align, and the detent ball 164 rests partially out of the first detent cavity 160 and partially into the second detent cavity 166, biased in place by the detent spring 162.

When a user key 40 is inserted into the lock and rotated away from the first rotated position, the inner surface 23 of the barrel portion 21 forces the detent ball 164 fully within the first detent cavity 160, where it is retained between the inner surface 23 and the detent spring 162. When the plug returns to the first rotated position, the first detent and the second detent cavities 160 and 166 again align, and the user may hear and feel in the fingers, through the key, the impact of the detent ball 164 when driven by the detent spring 162 against the inside rim of the second detent cavity 166. This signals that the plug has been returned to the key insertion position, and is properly aligned in the housing for removal of the user key from the lock.

Typically the lock of the present invention can be configured with a second plug positioning means to provide a signal to the user that the plug has been rotated to the second rotated position (the temporary programming position), as shown in FIG. 13, for manipulating the change tool and programming the lock for temporary use with the temporary user key. The second programming means can use the first detent cavity 160, detent spring 162, and detent ball 164, and provides a third detent means, shown as hole or cavity 168, with which the first detent cavity aligns when the plug is rotated to the temporary programming position. This can allow the user to hear or feel through the key the impact of the detent ball 164 when driven by the detent spring 162 against the inside rim of the third detent cavity 168 when the plug arrives at the temporary programming position, and confirms the proper position of the plug for applying the force to manipulate the change tool within the change slot.

In a first method of making a programmable lock plug, a standard lock plug is provided and machined. This step typically comprises disassembling an existing standard lock, by removing the plug from the lock housing, and removing the hardware, such as springs and pins (the drivers, tumblers and any master shims) from the lock plug, thereby recovering the standard lock plug.

The standard lock plug has as a keyway, an axial centerline and a circumferential surface. The standard lock plug further has a plurality of tumbler chambers extending through the circumferential surface along a first line extending parallel to the axial centerline. Each tumbler chamber extends into the keyway and has a centerline that is spaced apart by a first distance from an adjacent tumbler chamber. Typically adjacent tumbler chambers are separated by the same first distance.

In the next step, the method provides machining a plurality of main retainer cavities, into the standard lock plug. The main retainer cavities are formed through the periphery surface along a second line extending parallel to the first line of the tumbler chambers. Each retainer cavity extends partially into the plug body. The second line is positioned whereby the retainer cavities are displaced radially from the first line of tumbler chambers by an arc angle along the circumferential surface. Typically, the arc angle is about 20° to about 160°, more typically about 30° to about 60°, offset from the first line. One main retainer cavity is machined for each pin chamber that is designated as a programmable pin chamber.

In a typical embodiment, the main retainer cavities are machined to a depth into the plug body of at least its diameter, more typically at least 105% of its diameter. Typical retainer cavity diameters are from about 0.050 inches (about 1.3 mm) to 0.090 inches (about 2.3 mm), and are typically of a size, or diameter, less than the diameter of the driver positioned within the driver chambers of the housing. More typically, the diameter of the retainer cavities are drilled to a diameter of about 95% and less than the size (diameter) of the driver. Typically, the retainer cavities are formed with a standard drilling machine.

In another step, the plug is machined to provide at least one temporary retainer cavity. The temporary retainer cavity is machined into the peripheral surface along a third line extending parallel to the first line, and displaced radially from both the first line of tumbler chambers and the second line of main retainer cavities. The third line is typically displaced from the first line by an arc of from 20° to about 160°, more typically about 60° to about 120°. A convenient position of the third line for the temporary retainer cavity is 90° from the first line of the tumbler chambers. The temporary retainer cavity is a circumferentially aligned with the pin chamber designed as the temporary pin chamber. The temporary retainer cavity is formed in a similar manner as a main retainer cavity.

In a next step, a change slot is formed into the plug as described herein before.

In another embodiment, the change slot 117 is cut along the axial direction in the outer surface of the plug proximate to the third line of the temporary retainer cavity. The slot is generally formed as a u-shaped or rectangular cross section, penetrating the circumferential surface of the plug and extending radially inward toward the center axis. The slot is typically formed having a depth of approximately the same depth as the temporary retainer cavity, and having a width of less than the diameter of a driver, and typically less than 0.10 inches (2.54 mm). The slot typically extends longitudinally from the front face of the plug toward the opposite latch end of the plug, passing through the temporary retainer cavity. The slot can be formed by any well known means, such as a circular saw or a broach.

After forming the main and temporary retainer cavities, and the change slot, the lock is then reassembled by reinstalling the drivers, tumblers, springs, and main and temporary change balls in a programmed arrangement. The change ball is typically a spherical change ball, sized to fit within the depth of the retainer cavity, as described herein above.

In a typically method, the plug body is secured, such as by clamps, for rotational movement about its center axis. The plug is first secured in a first position whereby the tumbler chambers register with a reference point. The reference point is registered with a drilling machine. The drilling machine operates a drilling bit that is rotated at a cutting speed, and can move the drilling bit along the axis of the drill bit from a first position outside the plug surface to a second position that penetrates a depth into the plug. The plug is then rotated about its axis to a second position, which is offset radially from the first position by the arc angle of the second line of main retainer cavities. The drilling machine is then operated to drill the plurality retainer cavity to its depth at each location corresponding to a programmable pin chamber. The drilling machine is also configured for movement along the longitudinal axis of the plug, whereby the successive retainer cavities can be drilled at the appropriate locations along the second line of the plug to form the plurality of retainer cavities. More typically, the drilling machine comprises a plurality of drilling bits that are configured spaced apart at the appropriate locations, whereby the plurality of retainer cavities can be machined simultaneously.

In a second method of making a programmable lock plug, a base lock plug is provided and machined. The base plug is typically a cylindrical body configured with a keyway. In this method, the tumbler chambers, the main retainer cavities, the temporary retainer cavity, and the change slot, are machined into the circumferential surface of the plug body. The plurality of tumbler chambers are machined, typically by a drilling machine, through the peripheral surface along a first line extending parallel to the axial centerline, wherein each tumbler chamber extends into the keyway. Typically, the tumbler chambers penetrate the plug surface at a position opposite (180°) from the base of the keyway.

The main retainer cavities are then machined through the peripheral surface along a second line as described above for the first method. In a typically method, the base plug body is secured, such as by clamps, for rotational movement about its center axis. The base plug is first secured in a position whereby a drilling machine registers with a reference point representing the axial centerline of a first retainer cavity. The drilling machine operates a drilling bit that is rotated at a cutting speed, and can move the drilling bit along the axis of the drill bit from a first position outside the plug surface to a second position that penetrates a depth into the plug. The drilling machine is configured for operation to drill the retainer cavity. The drilling machine is then moved along the longitudinal axis of the plug to a next position, corresponding to the axial centerline of the second retainer cavity. The drilling machine is again operated to drill the second retainer cavity. Successive retainer cavities can thus be machined. Alternatively, the drilling machine can comprise a plurality of drilling bits that are configured spaced apart, whereby all required retainer cavities can be machined simultaneously along the second line.

Alternatively, the set of tumbler chambers and retainer cavities can be machined into the base plug by separate drilling machines, sequentially or simultaneously, without requiring rotational movement of the plug body.

A temporary retainer cavity is then formed. The plug is rotated about its axis to a position that registers with the third line of the temporary retainer cavity. The drilling machine then operates to drill the temporary retainer cavity to its depth at its appropriate position relative to the temporary pin chamber, as described above.

A change slot is also formed proximate to the third line. In the illustrated embodiment, the change slot passes through the temporary retainer cavity. The change slot is typically machined with a rotating saw. The step of forming the change slot can be performed while the plug is in the same position as for the drilling of the temporary retainer cavity.

A typical way of forming the detent means during the making of the lock is described. While restraining the plug 10 from movement within the housing 20 and with the tumbler chambers 13 aligned with the driver chambers 24, a hole is drilled through the barrel portion 21 of the housing, which forms the second detent cavity 166, and partially into the plug 10. A small flat surface can be machined onto the outer surface of the barrel portion 21 to facilitate the drilling. The plug is then removed and a larger-diameter hole is drilled into the plug, centered on the smaller partial hole, to form the first detent cavity 160. A detent ball 164 on top of a detent spring 162 are then inserted and restrained in the first detent cavity 160 as the plug 10 is inserted into the barrel portion 21 of the housing. A preferred detent spring has a stainless steel wire of about size 013, and is available as part number C090x013x190 from W.B. Jones Spring Co., Inc., of Wilder, Ky.

The embodiments of a programmable lock assembly can be used in a variety of locking devices. These locking devices include both commercial and residential locks, and include by example, knob locks, deadbolt locks, and padlocks. The operation of a typical knob lock includes the use of the operable key both to unlock and lock the door knob by turning a latch that is secured to the latch end of the plug. The latch typically unlocks the door knob, which can then turn or rotate by hand, and thereby operate an elongated bolt that engages and disengages the jamb of the door or other object that is being locked. The operation of a typical dead-bolt lock includes the use of the operable key to unlock and rotate a latch that drivers an elongated bolt to engage and disengage the jamb of the door or other object that is being locked. These locks are well-known to one skilled in the art.

A preferred use of the lock of the present invention is for the outside door of a residential, apartment building, condominium, or office building. The lock and its set of user keys and temporary keys allow a user to temporarily enable access to one or more of the outside doors to permit one-time or temporary access by a third party, such as a repair person, relative, neighbor, or other. The regular user key can then be used such as when the homeowner returns, to both operate and reconfigure the lock again for the main user key, and disable operation by the temporary user key. The lock also allows the owner or the person responsible for door security, to change the lock configuration to operate with a different user key. The different user key is simply inserted to operate the lock and reconfigure the lock to operate with the different user key, and to cancel the previous user key.

While the invention has been disclosed by reference to the details of preferred embodiments of the invention, it is to be understood that the disclosure is intended in an illustrative rather than in a limiting sense, as it is contemplated that modifications will readily occur to those skilled in the art, within the spirit of the invention and the scope of the appended claims.

I claim:

1. A programmable lock assembly that can be reconfigured to operate with different keys of a set of at least one main user key and at least one temporary user key, without disassembling the lock, comprising:
a) a housing having a cylindrical bore with an inner surface and a plurality of driver chambers intersecting the inner surface;
b) a plurality of drivers movable within a driver chamber;
c) a plug having a cylindrical periphery and rotatably mounted within the bore, the plug being rotatable between a key insertion position, a temporary programming position, and a main programming position, the plug further having:
1) a keyway formed in the plug to receive a key selected from the set of keys for rotating the plug within the housing;
2) a plurality of tumbler chambers intersecting the plug periphery and the keyway, each tumbler chamber being aligned with a corresponding one of the driver chambers when the plug is at the key insertion position so as to form a pin chamber, the plurality of pin chambers including at least one programmable pin chamber and at least one temporary pin chamber;
3) at least one main lock configuration retainer cavity formed into the periphery, the main retainer cavity being spaced apart a first distance from the corresponding tumbler chamber associated with the programmable pin chamber, and being aligned with the corresponding driver chamber when the plug is rotated to the main programming position;
4) at least one temporary retainer cavity formed into the periphery, spaced apart a second distance from the corresponding tumbler chamber associated with the temporary pin chamber, and being aligned with the corresponding driver chamber when the plug is rotated to the temporary programming position; and
5) a change slot intersecting the temporary retainer cavity,
d) a plurality of tumblers, each tumbler being movable within the corresponding tumbler chamber;
e) at least one main lock configuration change member associated with the at least one programmable pin chamber, movable within the lock between a first position within the programmable pin chamber, and a second position within the at least one main retainer cavity,
f) a change tool configured for manipulation within the change slot; and
g) at least one temporary lock configuration change member associated with the at least one temporary pin chamber, movable within the lock between a first position within the at least one temporary pin chamber, and a second position within the at least one temporary retainer cavity, and being movable from the second position upon manipulation of the change tool in the change slot;
wherein the configuration of the lock is based upon the positioning of the at least one main change member and of the at least one temporary change member, and wherein the temporary user key can only rotate the plug from the key insertion position when the temporary change member is disposed in the temporary pin chamber.

2. The programmable lock assembly according to claim 1 wherein the at least one main lock configuration retainer cavity comprises a plurality of main lock configuration retainer cavities and wherein the at least one main lock configuration change member comprises a plurality of main lock configuration change members.

3. The programmable lock assembly according to claim 1 wherein a first of the at least one main user keys operates the lock in a first lock configuration having a first number of the main change members disposed in the first position, but does not operate the lock in a second lock configuration having a second number of main change members disposed in the first position that is less than the first number.

4. The programmable lock assembly according to claim 2 wherein each of the plurality of main user keys is associated with one of the plurality of corresponding temporary user keys, and wherein the temporary user key associated with an operable main user key can operate the lock when the temporary change member is positioned in the temporary pin chamber, but cannot operate the lock when the temporary change member is positioned in the temporary retainer cavity.

5. The programmable lock assembly according to claim 1 wherein the change tool comprises at least one biasing member associated with the temporary retainer cavity, the change tool being moveable between a first position where the biasing member does not intersect the temporary change cavity, and a second position where the biasing member does intersect the temporary change cavity.

6. The programmable lock assembly according to claim 5 wherein the change tool is integral with the plug.

7. The programmable lock assembly according to claim 6 wherein the change tool has an end disposed at the front face of the plug for manipulation of the change tool.

8. The programmable lock assembly according to claim 1 wherein the first main user key has a first contour edge, the second main user key has a second contour edge, wherein the first contour edge has a plurality of contour positions that comprise a plurality of lowered contours, and the second contour edge is the same as the first contour edge except that at least one of the plurality of lowered contours has been replaced with a raised contour.

9. The programmable lock assembly according to claim 1 wherein each of the at least one main user key has a raised contour position corresponding to the at least one temporary pin chamber, which can move the at least one temporary change member from the temporary pin chamber to the corresponding temporary retainer cavity when inserted into the keyway and rotated to the temporary programming position.

10. The programmable lock assembly according to claim 3 wherein, when the temporary change member is positioned within the temporary retainer cavity, the lock in the first lock configuration can be operated by the operable first main user key, and by a succeeding main user key.

11. The programmable lock assembly according to claim 8 wherein, when the at least one temporary change member is positioned within the temporary pin chamber, the lock can further be operated by the temporary user key associated with the operable first main user key and by a temporary user key associated with the succeeding main user key.

12. The programmable lock assembly according to claim 1, further comprising a main change tool comprising a plurality of biasing members moveable between a first position out of engagement with the main retainer cavities, and a second position into engagement with the main retainer cavities, wherein manipulation of the main change tool from the first position to the second position can displace a main change ball that is disposed within the main retainer cavity.

14. A programmable lock assembly that can be reconfigured to operate with different keys of a set of main user keys and temporary user keys, without disassembling the lock, comprising:
a) a housing having a cylindrical bore with an inner surface and a plurality of driver chambers intersecting the inner surface;
b) a plurality of drivers, each driver being movable within one driver chamber and being urged toward the bore;
c) a plug having a cylindrical periphery and rotatably mounted within the bore so as to form a shear line at the interface of the inner surface and the plug periphery, the plug being rotatable between a key insertion position, a temporary programming position, and a main programming position, the plug further having:
1) a keyway formed in the plug to receive a key selected from a subset of keys, the subset of keys including at least a first main user key having a first contour edge, and a second main user key having a second contour edge, wherein the first contour edge and the second contour edge each have a plurality of a contour position and are differently configured;
2) a plurality of tumbler chambers intersecting the plug periphery and the keyway, each tumbler chamber being aligned with one of the plurality of driver chambers when the plug is at the key insertion position so as to form a pin chamber, the plurality of pin chambers including a plurality of programmable pin chambers and at least one temporary pin chamber,
3) a plurality of main lock configuration retainer cavities formed into the periphery, each main retainer cavity being spaced apart a first distance from the corresponding main tumbler chamber associated with a programmable pin chamber, and being aligned with the corresponding driver chamber when the plug is at the main programming position;
4) at least one temporary lock configuration retainer cavity formed into the periphery, the at least one temporary retainer cavity being spaced apart a second distance from the corresponding tumbler chamber associated with the at least one temporary pin chamber, and aligned with the corresponding driver chamber when the plug is at the temporary programming position; and
5) a change slot that intersects a portion of the at least one temporary retainer cavity;
d) a plurality of tumblers, each tumbler being movable within the corresponding tumbler chamber;
e) a plurality of main lock configuration change members, each main change member being associated with one programmable pin chamber, and being movable within the lock between a first position within the corresponding programmable pin chamber, and a second position within the corresponding main retainer cavity,
f) a change tool configured for manipulation within the change slot; and
g) a temporary lock configuration change member associated with the at least one temporary pin chamber, and being movable within the lock between a first position within the at least one temporary pin chamber, and a second position within the at least one temporary retainer cavity, and being movable from the second position upon manipulation of the change tool in the change slot;
wherein a first main user key can operate the lock in a first lock configuration having a first number of the main change members disposed in the corresponding programmable pin chambers, but can not operate the lock in a second lock configuration having a second number of the main change members disposed in the corresponding programmable pin chamber that is less than the first number, and wherein the temporary user key associated with the main user key can only rotate the plug from the key insertion position when the at least one temporary change member is disposed in the first position.

15. The programmable lock assembly according to claim 14 wherein each main user key is configured to move the at least one temporary change member from the first position when inserted into the keyway and rotated to the temporary programming position.

16. The programmable lock assembly according to claim 14 wherein the first main user key has a contour edge having a plurality of a lowered contour, and the second main user key has a contour edge similar to the first main user key, except that at least one of the plurality of the lowered contours has been replaced by a raised contour.

17. A programmable lock assembly that can be reconfigured to operate with different keys of a set of keys comprising a main user key and a temporary user key, without disassembling the lock, comprising:
a) a housing having a cylindrical bore with an inner surface and a plurality of driver chambers intersecting the inner surface;
b) a plurality of drivers movable within a driver chamber;
c) a plug having a cylindrical periphery and rotatably mounted within the bore, the plug being rotatable between a key insertion position, a temporary programming position, and an operating position, the plug further having:
1) a keyway formed in the plug to receive a key selected from the set of keys;
2) a plurality of tumbler chambers intersecting the plug periphery and the keyway, each tumbler chamber being aligned with a driver chamber when the plug is at the key insertion position so as to form a pin chamber, the plurality of pin chambers including at least one temporary pin chamber;
3) at least one temporary retainer cavity formed into the periphery, spaced apart a second distance from the corresponding tumbler chamber associated with the at least one temporary pin chamber, and aligned with a corresponding driver chamber when the plug is rotated to the temporary programming position; and
4) a change slot that intersects the at least one temporary retainer cavity,
d) a plurality of tumblers movable within the corresponding tumbler chambers;
e) a change tool configured for manipulation within the change slot; and
f) at least one temporary lock configuration change member associated with each at least one temporary pin chamber, being movable within the lock between a first position within the temporary pin chamber, and a second position within the at least one temporary retainer cavity, and being movable from the second position upon manipulation of the change tool in the change slot;
wherein the at least one temporary user key can only rotate the plug away from the key insertion position when the temporary change member is in its first position.

18. The programmable lock assembly according to claim 17 wherein the main user key has a contour edge having a plurality of contour positions that comprise a raised contour position corresponding to the temporary pin chamber, which can move the temporary change member from the temporary pin chamber to the corresponding temporary retainer cavity when inserted into the keyway and rotated to the temporary programming position.

19. The programmable lock assembly according to claim 1 wherein the change tool comprises at least one biasing member associated with the temporary retainer cavity, the change tool being moveable between a first position where the biasing member does not intersect the temporary change cavity, and a second position where the biasing member does intersect the temporary change cavity.

20. The programmable lock assembly according to claim 17 wherein the change tool is integral with the plug.
